(19) United States
(12) Patent Application Publication
(10) Pub. No.: US 2026/0353005 A1
(43) Pub. Date: Nov. 5, 2026

(54) NEAR-FIELD SURROUND SOUND SYSTEM

(71) Applicant: SHENZHEN DEKANGXING TECHNOLOGY CO., LTD, Shenzhen (CN)

(72) Inventor: Pengfeng ZHANG, Shenzhen (CN)

(21) Appl. No.: 19/710,764

(22) Filed: Jun. 17, 2026

Related U.S. Application Data
(63) Continuation of application No. PCT/CN2024/139858, filed on Dec. 17, 2024.

(30) Foreign Application Priority Data
Jan. 24, 2024 (CN) 202410099291.8

(51) Int. Cl. H04R 5/033; H04R 1/10; H04S 3/00

(52) U.S. Cl. CPC H04R 5/0335; H04R 1/1008; H04R 1/1066; H04R 1/1075; H04S 3/008; H04S 2400/01

(57) ABSTRACT

A near-field surround sound system is provided, including: a headband main body provided with connecting portions at two ends; auxiliary clamping frames arranged adjacent to upper ends of the connecting portions, where the auxiliary clamping frames are connected to two side surfaces of the headband main body, and curvatures of the auxiliary clamping frames are configured to correspond to curvatures of two sides of the head; flexible pads arranged on end surfaces of the headband main body and the auxiliary clamping frames that abut against the head; two near-ear speaker modules respectively connected to the two connecting portions. Each near-ear speaker module includes a plurality of speaker units. When a user wears the headband main body, the connecting portions are configured to cause the near-ear speaker modules to be not in contact with the ears of the user.

### TECHNICAL FIELD

The present disclosure relates to the technical field of high-end headphone devices, and specifically, to a near-field surround sound system.

### BACKGROUND

Headphones are generally divided into two main categories: in-ear headphones and over-ear headphones. The over-ear headphone generally includes a headband and ear cups. Speakers of the headphone are disposed within the ear cups. Compared to the in-ear headphone, the over-ear headphone can employ larger speakers with superior sound quality performance, so that the over-ear headphone is highly favored by audiophiles who have high requirements for audio listening.

At present, to enhance an audio listening effect, the over-ear headphone is generally designed to be relatively closed and is clamped and worn on the user's head by virtue of the elasticity of the headband. Wearing this headphone easily leads to discomfort such as stuffiness and sweating in users, which affects the user experience. In addition, this easily leads to bacterial growth and hygiene issues, which may harm the user's ear health. Secondly, the existing headphones, whether over-ear or in-ear, shield the function of the human auricles in sound direction identification, resulting in degraded stereo and surround sound effects. Although some products adopt algorithms such as virtual surround sound and a head-related transfer function (HRTF) to implement direction identification, their direction identification accuracy is significantly lower than that of the human auricles.

### SUMMARY

In view of the above problems, the present disclosure mainly provides a near-field surround sound system, which aims to improve a structure of an over-ear headphone, solve the problem of stuffiness during wearing, enhance surround sound quality of playback of the headphone, and fully use the direction identification function of the human auricles.

To achieve the above objectives, the present disclosure provides a near-field surround sound system, including:
a headband main body provided with connecting portions at two ends;
auxiliary clamping frames arranged adjacent to upper ends of the connecting portions, wherein the auxiliary clamping frames are connected to two side surfaces of the headband main body, and curvatures of the auxiliary clamping frames are configured to correspond to curvatures of two sides of the head;
flexible pads arranged on end surfaces of the headband main body and the auxiliary clamping frames that about against the head; and
two near-ear speaker modules respectively connected to the two connecting portions, wherein each near-ear speaker module includes a plurality of speaker units; and when a user wears the headband main body, the connecting portions are configured to cause the near-ear speaker modules to be not in contact with the ears of the user.

Further, a top speaker module is included, which is connected to the headband main body and is approximately arranged at a top end of the headband main body, with a sound outlet surface facing the head.

Further, the near-field surround sound system includes at least one middle speaker module arranged at any one of the following positions: in the auxiliary clamping frames, adjacent to the auxiliary clamping frames, and in the connecting portions. The middle speaker module is configured to receive any one of left and right surround channel signals, left upper and right upper surround channel signals, a bass channel signal, and a center channel signal.

Further, at least one of the two near-ear speaker modules is provided with a microphone.

Further, when the user wears the headband main body, distances between the near-ear speaker modules and the auricles of the ears of the user are 5 mm to 80 mm through the connecting portions.

Further, the plurality of speaker units in each near-ear speaker module include five full-range speaker units and one bass speaker unit that are arranged in three layers. A middle layer includes three of the full-range speaker units, and the other two full-range speaker units and a sound outlet end of the bass speaker unit are respectively arranged above and below the full-range speaker units of the middle layer.

Based on a correspondence relationship between the near-ear speaker modules and the left and right ears, a front-rear layout relationship of the plurality of speaker units in each near-ear speaker module is as follows:

One of the full-range speaker units in an upper layer is configured to receive an upper front surround channel signal, and the other full-range speaker unit in the upper layer is configured to receive an upper rear surround channel signal.

Among the full-range speaker units in the middle layer, a rear full-range speaker unit is configured to receive a rear surround channel signal. As for the other two full-range speaker units, when a middle full-range speaker unit is configured to receive a front surround channel signal, a front full-range speaker unit is configured to receive left and right channel signals, or when the middle full-range speaker unit is configured to receive the left and right channel signals, the front full-range speaker unit is configured to receive the front surround channel signal.

The bass speaker unit is configured to receive a bass channel signal.

Further, the near-field surround sound system includes an external speaker. The plurality of speaker units in each near-ear speaker module include five full-range speaker units that are arranged in an upper layer and a lower layer. The lower layer includes three full-range speaker units and the upper layer includes two full-range speaker units.

Based on a correspondence relationship between the near-ear speaker modules and the left and right ears, a front-rear layout relationship of the plurality of speaker units in each near-ear speaker module is as follows:

A front full-range speaker unit in the upper layer is configured to receive an upper front surround channel signal, and a rear full-range speaker unit in the upper layer is configured to receive an upper rear surround channel signal.

Among the full-range speaker units in the lower layer, a rear full-range speaker unit is configured to receive a rear surround channel signal. As for the other two full-range speaker units, when a middle full-range speaker unit is configured to receive a front surround channel signal, a front full-range speaker unit is configured to receive left and right channel signals, or when the middle full-range speaker unit is configured to receive the left and right channel signals, the front full-range speaker unit is configured to receive the front surround channel signal.

The external speaker is configured to receive a bass channel signal.

Further, the top speaker module is arranged on a front side of the headband main body; the top speaker module is a bass speaker unit or a full-range speaker unit and is configured to receive a bass channel signal.

Further, at least one top speaker module is provided, which is arranged on a front side and/or a rear side of the headband main body and is configured to receive a surround channel signal.

Further, the top speaker module includes two speaker units respectively arranged on a front side of the headband main body and on a lower end surface of a top end of the headband main body or at a position, close to the lower end surface of the top end of the headband main body, on the front side of the headband main body. The speaker unit arranged on the front side of the headband main body is configured to receive a center channel signal. The speaker unit arranged on the lower end surface of the top end of the headband main body or at the position, close to the lower end surface of the top end of the headband main body, on the front side of the headband main body is configured to receive an upper surround channel signal.

Further, the top speaker module includes three speaker units respectively arranged on a front side and a rear side of the headband main body to receive front and rear upper surround channel signals and on a lower end surface of a top end of the headband main body to receive a bass channel signal.

Further, the near-field surround sound system includes a supporting plate. The supporting plate is at least connected to a front side of a top end of the headband main body, and a curvature of the supporting plate conforms to a crown curvature of the head. The top speaker module is connected to the headband main body through the supporting plate.

Further, the near-field surround sound system includes a top-front speaker unit arranged on a front side of a top of the headband main body and configured to receive a center channel signal; a flexibly supplementary speaker unit configured to receive a flexibly supplementary channel signal; and at least one middle speaker module which is arranged at any one of the following positions: in the auxiliary clamping frames, adjacent to the auxiliary clamping frames, and in the connecting portions, and is configured to receive a flexibly supplementary channel signal. The plurality of speaker units in each near-ear speaker module include five full-range speaker units and one bass speaker unit that are disposed in three layers. A middle layer includes three full-range speaker units, and the other two full-range speaker units and the bass speaker unit are respectively disposed above and below the middle layer.

Based on a correspondence relationship between the near-ear speaker modules and the left and right ears, a front-rear layout relationship of the plurality of speaker units in each near-ear speaker module is as follows:

One of the full-range speaker units in an upper layer is configured to receive an upper front surround channel signal, and the other full-range speaker unit in the upper layer is configured to receive an upper rear surround channel signal.

Among the full-range speaker units in the middle layer, a rear full-range speaker unit is configured to receive a rear surround channel signal. As for the other two full-range speaker units, when a middle full-range speaker unit is configured to receive a front surround channel signal, a front full-range speaker unit is configured to receive left and right channel signals, or when the middle full-range speaker unit is configured to receive the left and right channel signals, the front full-range speaker unit is configured to receive the front surround channel signal.

The bass speaker unit is configured to receive a bass channel signal.

Further, by using an entrance of the left ear canal as a central origin, introducing a planar rectangular coordinate system with an X axis and a Y axis, and using a negative axial line of the Y axis as a starting line, when the near-field surround sound system is worn in a top-view projection, a layout of the speaker units on the top and the left side of the near-field surround sound system is as follows:
an angle formed by a connecting line from a position point of the front full-range speaker unit in the middle layer to the central origin and the starting line is 15° to 45°;
an angle formed by a connecting line from a position point of the middle full-range speaker unit in the middle layer to the central origin and the starting line is 70° to 110°;
an angle formed by a connecting line from a position point of the rear full-range speaker unit in the middle layer to the central origin and the starting line is 120° to 165°;
an angle formed by a connecting line from a position point of the full-range speaker unit for receiving the upper front surround channel signal in the upper layer to the central origin and the starting line is 65° to 80°;
an angle formed by a connecting line from a position point of the full-range speaker unit for receiving the upper rear surround channel signal in the upper layer to the central origin and the starting line is 110° to 125°;
an angle formed by a connecting line from a position point of the top-front speaker unit to the central origin and the starting line is −20° to −60°;
an angle formed by a connecting line from a position point of the flexibly supplementary speaker unit to the central origin and the starting line is −110° to −150°.

By using the entrance of the left ear canal as the central origin, introducing a space rectangular coordinate system with an X axis, a Y axis, and a Z axis, and using a positive axial line of the X axis as a starting line, when the near-field surround sound system is worn in a right-view projection, an angle formed by a connecting line from a position point of the full-range speaker unit in the upper layer on a left side of the near-field surround sound system to the central origin and the starting line is 30° to 70°.

The plurality of speaker units in each near-ear speaker module include two full-range speaker units. Based on a correspondence relationship between the near-ear speaker modules and the left and right ears, the two full-range speaker units in each near-ear speaker module are disposed front and rear. The front full-range speaker unit is configured to receive a center channel signal and left and right channel signals. The rear full-range speaker unit is configured to receive rear left and right surround channel signals.

Further, the plurality of speaker units in each near-ear speaker module include three full-range speaker units. Based on a correspondence relationship between the near-ear speaker modules and the left and right ears, the three full-range speaker units in each near-ear speaker module are disposed front, middle, and rear.

The front full-range speaker unit is configured to receive a center channel signal and left and right channel signals, or left and right front surround channel signals.

The middle full-range speaker unit is configured to receive any one of left and right front surround channel signals and left and right channel signals.

The rear full-range speaker unit is configured to receive rear left and right rear surround channel signals.

Further, the plurality of speaker units in each near-ear speaker module include three speaker units. Based on a correspondence relationship between the near-ear speaker modules and the left and right ears, the three speaker units in each near-ear speaker module are disposed in two layers. An upper layer includes two speaker units that are disposed front and rear.

The front speaker unit in the upper layer is configured to receive a center channel signal and left and right channel signals, or left and right front surround channel signals

The rear speaker unit in the upper layer is configured to receive left and right rear surround channel signals.

The speaker unit in the lower layer is configured to receive rear bass channel signals.

Further, the plurality of speaker units in each near-ear speaker module include four speaker units. Based on a correspondence relationship between the near-ear speaker modules and the left and right ears, the four speaker units in each near-ear speaker module are disposed in two layers, and an upper layer includes three speaker units that are disposed front, middle, and rear.

The front speaker unit in the upper layer is configured to receive a center channel signal and left and right channel signals, or left and right front surround channel signals.

The middle speaker unit in the upper layer is configured to receive a center channel signal and left and right channel signals, or left and right front surround channel signals.

The rear speaker unit in the upper layer is configured to receive left and right rear surround channel signals.

The speaker unit in the lower layer is configured to receive rear bass channel signals.

Further, the plurality of speaker units in each near-ear speaker module include four full-range speaker units. Based on a correspondence relationship between the near-ear speaker modules and the left and right ears, the four full-range speaker units in each near-ear speaker module are disposed in three layers, and a middle layer includes two full-range speaker units that are disposed front and rear.

The full-range speaker unit in the upper layer is configured to receive left and right upper surround channel signals.

The front full-range speaker unit in the middle layer is configured to receive a center channel signal and left and right channel signals, or left and right front surround channel signals.

The rear full-range speaker unit in the middle layer is configured to receive left and right rear surround channel signals.

The full-range speaker unit in the lower layer is configured to receive a center channel signal and left and right channel signals, or left and right front surround channel signals, or bass channel signal.

Further, the plurality of speaker units in each near-ear speaker module include four full-range speaker units. Based on a correspondence relationship between the near-ear speaker modules and the left and right ears, the four full-range speaker units in each near-ear speaker module are disposed in two layers, and each of an upper layer and a lower layer includes two full-range speaker units that are disposed front and rear.

The front full-range speaker unit in the upper layer is configured to receive left and right upper front surround channel signals.

The rear full-range speaker unit in the upper layer is configured to receive left and right upper rear surround channel signals.

The front full-range speaker unit in the lower layer is configured to receive a center channel signal and left and right channel signals.

The rear full-range speaker unit in the lower layer is configured to receive left and right surround channel signals.

Further, the plurality of speaker units in each near-ear speaker module include five speaker units. Based on a correspondence relationship between the near-ear speaker modules and the left and right ears, four of the speaker units in each near-ear speaker module are disposed in two layers. Each of an upper layer and a lower layer includes two speaker units that are disposed front and rear. The fifth speaker unit is disposed between the four speaker units.

The front speaker unit in the upper layer is configured to receive left and right upper front surround channel signals.

The rear speaker unit in the upper layer is configured to receive left and right upper rear surround channel signals.

The front speaker unit in the lower layer is configured to receive a center channel signal and left and right channel signals.

The rear speaker unit in the lower layer is configured to receive left and right surround channel signals.

The fifth speaker unit is configured to receive bass channel signals.

Further, the plurality of speaker units in each near-ear speaker module include five speaker units. Based on a correspondence relationship between the near-ear speaker modules and the left and right ears, the five speaker units in each near-ear speaker module are disposed in three layers. A middle layer includes three speaker units that are disposed front, middle, and rear.

The speaker unit in the upper layer is configured to receive left and right upper surround channel signals.

The front speaker unit in the middle layer is configured to receive a center channel signal and left and right channel signals, or left and right front surround channel signals.

The middle speaker unit in the middle layer is configured to receive a center channel signal and left and right channel signals, or left and right front surround channel signals.

The rear speaker unit in the middle layer is configured to receive left and right rear surround channel signals.

The speaker unit in the lower layer is configured to receive bass channel signals.

Further, the near-ear speaker modules are connected to the headband main body through the connecting portions in an adjustable manner. When the user wears the headband main body, the near-ear speaker modules can adjust distances from the auricles of the ears of the user by 5 mm to 80 mm through the connecting portions.

Compared with the prior art, the near-field surround sound system provided in the present disclosure can solve the problem of discomfort such as stuffiness and sweating because the conventional over-ear headphone encloses and covers the ears of a user. Furthermore, since the plurality of speaker units are disposed within the near-ear speaker modules, compared with a sound production unit with a single horn, the plurality of speaker units can constitute the near-field surround sound system which has a better listening experience. The curvatures of the auxiliary clamping frames are designed to correspond to the curvatures of the two sides of the head, so that the auxiliary clamping frames can better abut against the head of the user, and the connection is more stable. Meanwhile, this product has the direction identification function of the human auricles, thereby making a sound direction more accurate.

### BRIEF DESCRIPTION OF THE DRAWINGS

FIG. 1 is a front view of a near-field surround sound system according to the present disclosure.

FIG. 2 is a right view of a near-field surround sound system according to the present disclosure.

FIG. 3 is a schematic diagram of Embodiment 10 of a near-field surround sound system according to the present disclosure.

FIG. 4 is a schematic diagram of Embodiment 6, Embodiment 7, Embodiment 8, and Embodiment 9 of a near-field surround sound system according to the present disclosure.

FIG. 5 is a schematic diagram of Embodiment 11 of a near-field surround sound system according to the present disclosure.

FIG. 6 is a schematic diagram of a structure of Embodiments 12 to 17 of a near-field surround sound system according to the present disclosure.

FIG. 7 is a schematic diagram of a structure of Embodiment 18 of a near-field surround sound system according to the present disclosure.

FIG. 8 is a schematic diagram of a structure of Embodiment 19 of a near-field surround sound system according to the present disclosure.

FIG. 9 is a schematic diagram of a structure of Embodiment 21 of a near-field surround sound system according to the present disclosure.

FIG. 10 is a schematic diagram of a structure of Embodiment 22 to Embodiment 23 of a near-field surround sound system according to the present disclosure.

FIG. 11 is a schematic diagram of distribution of speaker units in Embodiment 22 or Embodiment 23 of a near-field surround sound system according to the present disclosure.

FIG. 12 is a schematic diagram of distribution of speaker units in Embodiment 22 or Embodiment 23 of a near-field surround sound system according to the present disclosure.

FIG. 13 is a schematic diagram of distribution of speaker units in Embodiment 22 or Embodiment 23 of a near-field surround sound system according to the present disclosure.

FIG. 14 is a schematic diagram of a structure of a near-field surround sound system according to the present disclosure, showing that side-view projection contours of connecting portions are curved arc structures.

FIG. 15 is a schematic diagram of a structure of another embodiment of a near-field surround sound system according to the present disclosure, showing that side-view projection contours of connecting portions are curved arc structures.

FIG. 16 is a schematic diagram of distribution of speaker units in Embodiment 24 of a near-field surround sound system according to the present disclosure.

FIG. 17 is a schematic diagram of distribution of speaker units in Embodiment 25 of a near-field surround sound system according to the present disclosure.

FIG. 18 is a schematic diagram of distribution of speaker units in Embodiment 26 of a near-field surround sound system according to the present disclosure.

FIG. 19 is a schematic diagram of distribution of speaker units in Embodiment 27 of a near-field surround sound system according to the present disclosure.

FIG. 20 is a schematic diagram of distribution of speaker units in Embodiment 28 of a near-field surround sound system according to the present disclosure.

FIG. 21 is a schematic diagram of distribution of speaker units in Embodiment 29 of a near-field surround sound system according to the present disclosure.

FIG. 22 is a schematic diagram of distribution of speaker units in Embodiment 30 of a near-field surround sound system according to the present disclosure.

FIG. 23 is a schematic diagram of distribution of speaker units in Embodiment 31 of a near-field surround sound system according to the present disclosure.

FIG. 24 is a schematic diagram of Embodiment 32 of a near-field surround sound system according to the present disclosure.

FIG. 25 is a schematic diagram of Embodiment 33 of a near-field surround sound system according to the present disclosure.

Reference numerals in the drawings: 1: headband main body; 110: connecting portion; 2: auxiliary clamping frame; 210: front clamping plate; 220: rear clamping plate; 3: flexible pad; 4: near-ear speaker module; 410: upper-front transducer; 420: upper-rear transducer; 430: middle-middle transducer; 440: middle-front transducer; 450: middle-rear transducer; 460: lower transducer; 470: main supporting housing; 471: acoustic cavity channel; 480: auxiliary supporting housing; 490: connecting arm; 5: top speaker module; 510: front-top transducer; 520: rear-top transducer; 530: middle-top transducer; 550: top-front transducer; 6: middle speaker module; 710: main microphone; 720: reference microphone; 8: external speaker; 9: supporting plate; 910: front supporting plate; 920: rear supporting plate; and 10: flexibly supplementary speaker unit.

### DETAILED DESCRIPTION OF THE EMBODIMENTS

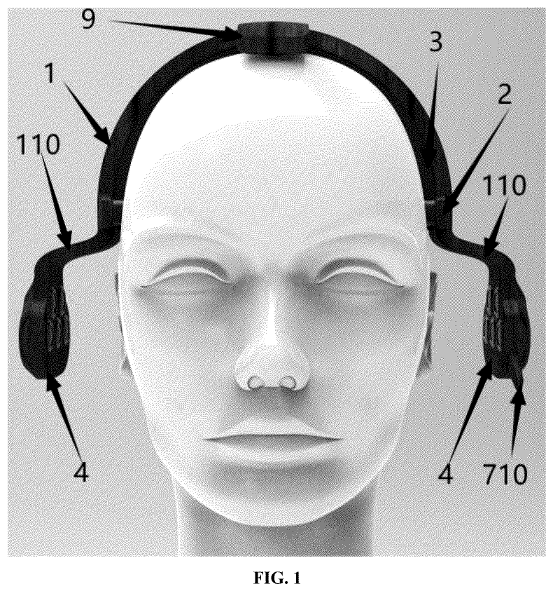

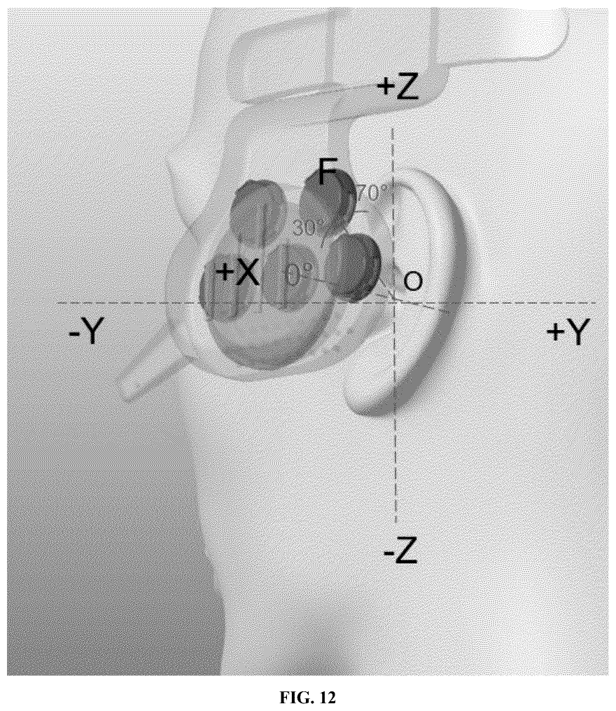

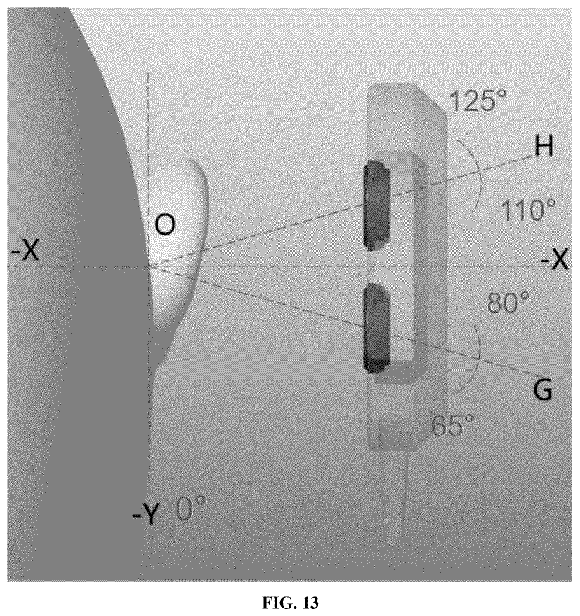

Referring to FIG. 1 to FIG. 23, this embodiment provides a near-field surround sound system, including:
a headband main body 1 provided with connecting portions 110 at two ends;
auxiliary clamping frames 2 arranged adjacent to upper ends of the connecting portions 110, where the auxiliary clamping frames 2 are connected to two side surfaces of the headband main body 1, and curvatures of the auxiliary clamping frames 2 are configured to correspond to curvatures of two sides of the head;
flexible pads 3 arranged on end surfaces of the headband main body 1 and the auxiliary clamping frames 2 that abut against the head; and
two near-ear speaker modules 4 respectively connected to the two connecting portions 110, where each near-ear speaker module 4 includes a plurality of speaker units. When a user wears the headband main body 1, the connecting portions 110 are configured to cause the near-ear speaker modules 4 to be not in contact with the ears of the user.

When the system is worn on the head of a user, horizontal levels of connection positions of the connecting portions 110 with the headband main body 1 are above the upper parts of the ears of the user. The connecting portions 110 can be frame or plate structures integrated with the headband main body 1 and extend slantways from the connection positions with the headband main body 1 in a direction away from the ears of the user. The other ends are connected to the near-ear speaker modules 4, so that the near-ear speaker modules 4 are not in contact with the ears of the user. Since the conventional over-ear headphone primarily uses headphone ear cups to enclose and clamp the ears and head of the user for stable wearing, this embodiment does not include the structures for enclosing and clamping the ears and head of the user at the original positions of the headphone ear cups, but employs the auxiliary clamping frames 2 to clamp the two sides of the head of the user, namely to clamp areas close to the ear bases of the two ears, thus solving the problem in stability of connection between the system and the head of the user.

Therefore, the near-field surround sound system can solve the problem of discomfort such as stuffiness and sweating because the conventional over-ear headphone encloses and covers the ears of a user. Furthermore, since the plurality of speaker units are disposed within the near-ear speaker modules 4, compared with a sound production unit with a single horn, the plurality of speaker units can constitute the near-field surround sound system, thus providing a better listening experience. Meanwhile, this product has the direction identification function of the human auricles, thereby making a sound direction more accurate.

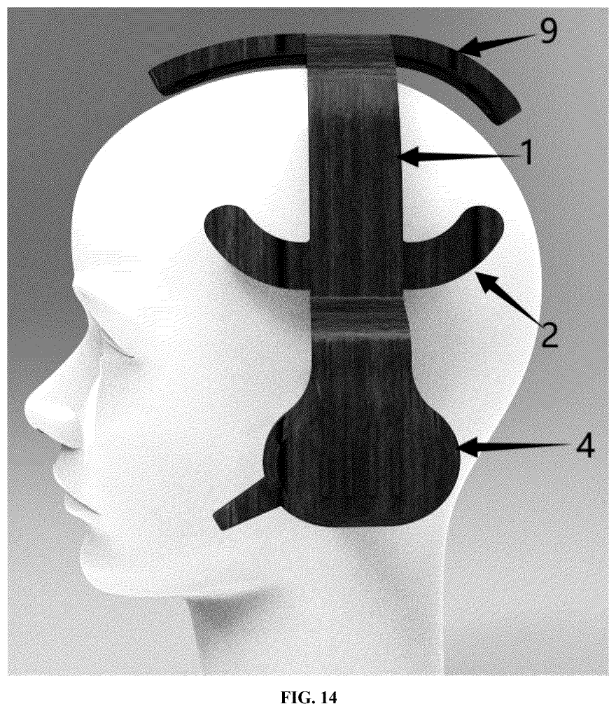

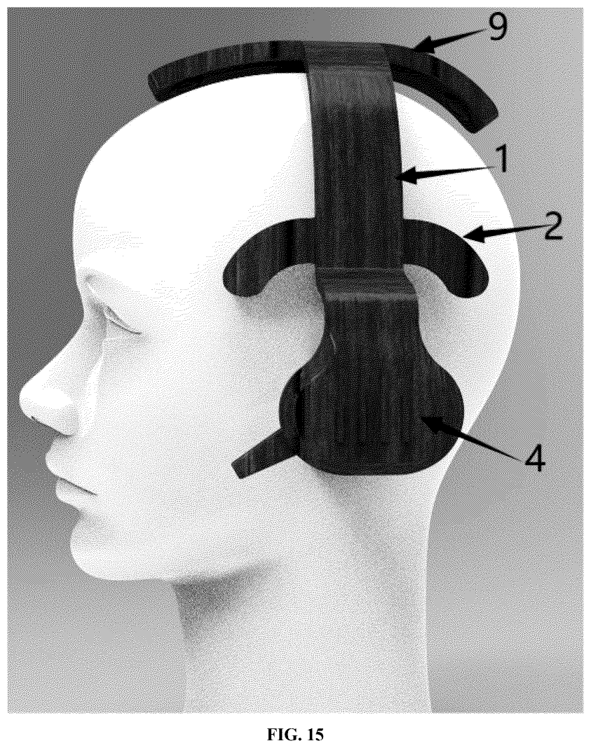

In some embodiments, the auxiliary clamping frames 2 may be structures integrated with the headband main body 1, or may be frames or plates. Each auxiliary clamping frame 22 is divided into two portions: a portion extending forward from two side surfaces of the headband main body 1 is a front clamping plate 210, and a portion extending backward from the two side surfaces of the headband main body 1 is a rear clamping plate 220. When viewed from a side view of the system, projections of connection contours of the auxiliary clamping frames 2 and the headband main body 1 are in a “cross” shape. However, projection contours of the front clamping plate 210 and the rear clamping plate 220 is not limited to a straight arm shape. Referring to FIG. 14 and FIG. 15, the auxiliary clamping frames 2 have curved projection contours and are respectively of a structure with an end portion that is upward in a horizontal level direction and a structure with an end portion that is downward in the horizontal level direction.

Designing the curvatures of the auxiliary clamping frames 2 to correspond to the curvatures of the two sides of the head can make the auxiliary clamping frames 2 better abut against the head of a user, and the connection is more stable. In some embodiments, the auxiliary clamping frames 2 are adjustably connected to the headband main body 1 to adjust a clamping force of the system on the head of the user. For example, the auxiliary clamping frames 2 are of metal gooseneck structures that can be manually directly adjusted. The auxiliary clamping frames 2 are hinged to the headband main body 1. Elastic forces of torsional springs are applied to the auxiliary clamping frames 2, so that the auxiliary clamping frames 2 rotate in a direction of abutting against the head of the user.

By the arrangement of the flexible pads 3, a buffering and pressure reducing effect can be achieved, and the wearing comfort of the user can be enhanced. In some embodiments, the flexible pads 3 are vibration isolation sponges.

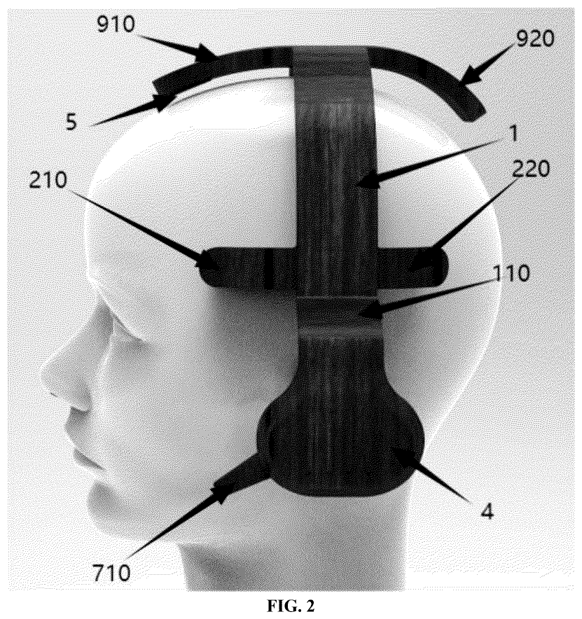

Referring to FIG. 2 and FIG. 6 to FIG. 11, a top speaker module 5 is included, which is connected to the headband main body 1 and is approximately arranged at a top end of the headband main body 1, with a sound outlet surface facing the head.

### Embodiment 1

By adding the top speaker module 5 at the top end of the headband main body 1, with the sound output surface facing the head of a user, the completeness of the near-field surround sound system can be further enhanced in combination with debugging of electronic hardware and software, thus greatly enhancing the user experience, and the near-field surround sound system matches a standard professional home theater sound system.

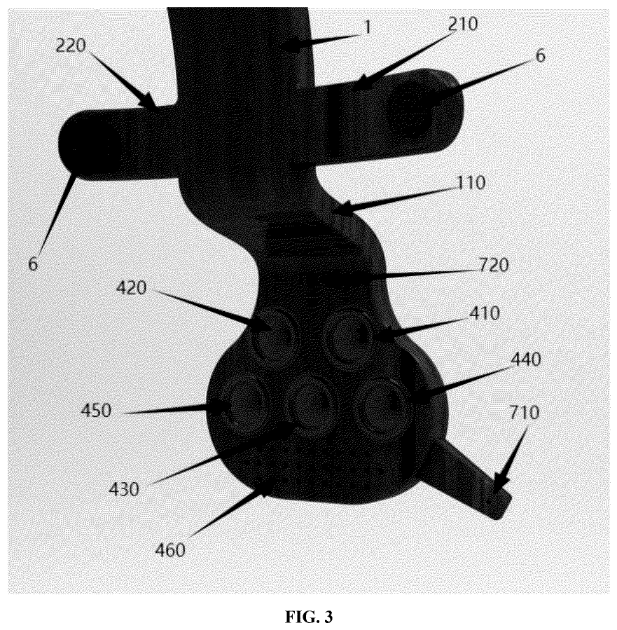

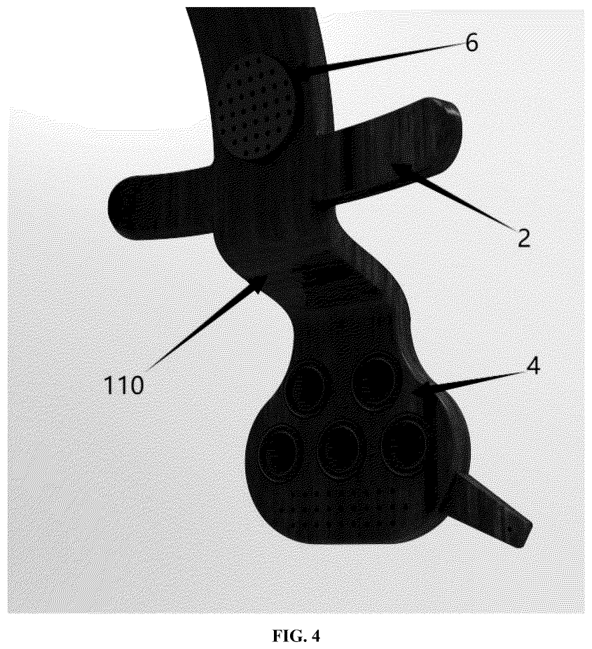

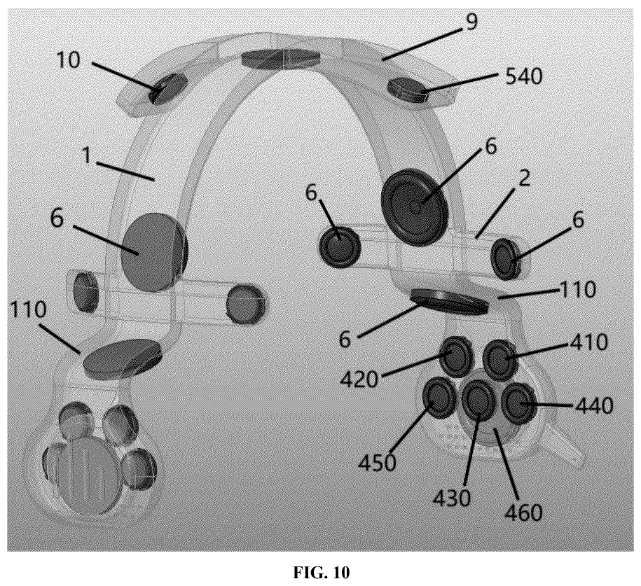

Referring to FIG. 3, FIG. 4, and FIG. 10, at least one middle speaker module 6 is included, which is arranged at any one of the following positions: in the auxiliary clamping frames 2, adjacent to the auxiliary clamping frames 2, and in the connecting portions 110. The middle speaker module 6 is configured to receive any one of left and right surround channel signals, left upper and right upper surround channel signals, left front and right front surround channel signals, left rear and right rear surround channel signals, a bass channel signal, a center channel signal, and a combination of the foregoing one or more signals.

### Embodiment 2

Referring to FIG. 3, each middle speaker module 6 includes two speaker units. The left half side of the system is used as an example. One speaker unit is disposed within each of the front clamping plate 210 and the rear clamping plate 220 of the auxiliary clamping frame 2 on the left half side. The two speaker units respectively receive left front and left rear surround channel signals. The speaker units in the auxiliary clamping frame 2 on the right half side correspondingly receive right front and right rear surround channel signals. The near-field surround sound system can be formed in combination with the tuning of the electronic hardware and software.

### Embodiment 3

Referring to FIG. 3, the middle speaker module 6 includes two speaker units. The left half side of the headphone is used as an example. One speaker unit is disposed within each of the front clamping plate 210 and the rear clamping plate 220 of the auxiliary clamping frame 2 on the left half side. The two speaker units respectively receive left front upper and left rear upper surround channel signals. The speaker units in the auxiliary clamping frame 2 on the right half side correspondingly receive right front upper and right rear upper surround channel signals. The near-field surround sound system can be formed in combination with the tuning of the electronic hardware and software.

### Embodiment 4

Referring to FIG. 3, the middle speaker module 6 includes two speaker units. The left half side of the headphone is used as an example. One speaker unit is disposed within each of the front clamping plate 210 and the rear clamping plate 220 of the auxiliary clamping frame 2 on the left half side. The two speaker units receive a bass channel signal. The speaker units in the auxiliary clamping frame 2 on the right half side also receive a bass channel signal.

### Embodiment 5

Referring to FIG. 3, the middle speaker module 6 includes two speaker units. The left half side of the headphone is used as an example. One speaker unit is disposed within each of the front clamping plate 210 and the rear clamping plate 220 of the auxiliary clamping frame 2 on the left half side. The two speaker units respectively receive front and rear center channel signals. The speaker units in the auxiliary clamping frame 2 on the right half side also respectively receive front and rear center channel signals.

### Embodiment 6

Referring to FIG. 4, the middle speaker module 6 includes one speaker unit. The left half side of the headphone is used as an example. The speaker unit is adjacent to the auxiliary clamping frame 2. In one embodiment, the speaker unit is disposed between the front clamping plate 210 and the rear clamping plate 220. That is, in the headband main body 1, the speaker unit is at a position slightly above a horizontal level of the auxiliary clamping frame 2, and receives a left surround channel signal. The speaker unit at a symmetric position on the right half side correspondingly receives a right surround channel signal.

### Embodiment 7

Referring to FIG. 4, the middle speaker module 6 includes one speaker unit. The left half side of the headphone is used as an example. The speaker unit is adjacent to the auxiliary clamping frame 2. In one embodiment, the speaker unit is disposed between the front clamping plate 210 and the rear clamping plate 220. That is, in the headband main body 1, the speaker unit is at a position slightly above a horizontal level of the auxiliary clamping frame 2, and receives a left upper surround channel signal. The speaker unit at a symmetric position on the right half side correspondingly receives a right upper surround channel signal.

### Embodiment 8

Referring to FIG. 4, the middle speaker module 6 includes one speaker unit. The left half side of the headphone is used as an example. The speaker unit is adjacent to the auxiliary clamping frame 2. In one embodiment, the speaker unit is disposed between the front clamping plate 210 and the rear clamping plate 220. That is, in the headband main body 1, the speaker unit is at a position slightly above a horizontal level of the auxiliary clamping frame 2, and receives a bass channel signal. The speaker unit at a symmetric position on the right half side also receives a bass channel signal.

### Embodiment 9

Referring to FIG. 4, the middle speaker module 6 includes one speaker unit. The left half side of the headphone is used as an example. The speaker unit is adjacent to the auxiliary clamping frame 2. In one embodiment, the speaker unit is disposed between the front clamping plate 210 and the rear clamping plate 220. That is, in the headband main body 1, the speaker unit is at a position slightly above a horizontal level of the auxiliary clamping frame 2, and receives a center channel signal. The speaker unit at a symmetric position on the right half side also receives a center channel signal.

Referring to FIG. 10, in one preferable embodiment, the left half side of the system is used as an example. The middle speaker module 6 is disposed within the connecting portion 110 on the left half side. Compared with Embodiment 2 to Embodiment 8, a sound outlet end of the middle speaker module 6 may be in contact with the head of a user and blocked, so that this may affect sound outputting. The setting in this embodiment is more appropriate. The middle speaker module 6 is disposed within the connecting portion 110 and is configured to receive any one of left and right surround channel signals, left upper and right upper surround channel signals, left front and right front surround channel signals, left rear and right rear surround channel signals, a bass channel signal, and a center channel signal. The speaker unit at a symmetric position on the right half side also correspondingly receives a corresponding channel signal.

Referring to FIG. 1 to FIG. 3, at least one of the two near-ear speaker modules 4 is provided with a microphone.

In some embodiments, two microphones are provided, including a main microphone 710 which is arranged at an edge of the near-ear speaker module 4 on the right side and extends toward the mouth of a user to play a role in collecting user's voice during voice calls, and a reference microphone 720 which is arranged above the plurality of speaker units in the near-ear speaker module 4, acquires sounds outputted by the plurality of speaker units, and then transmits the voices to a related analysis processing module for analysis to adjust and optimize an output effect in real time. It can further acquire external sound environment and automatically adjust speaker volumes of other speaker units connected to or indirectly connected to the near-ear speaker module 4 and the headband main body 1.

This function can be achieved in the prior art and is not an innovation of the present disclosure, so that it is not described in detail herein.

Preferably, when the user wears the headband main body, distances between the near-ear speaker modules and the auricles of the ears of the user are 5 mm to 80 mm through the connecting portions.

Via experimental tests, when the distances between the near-ear speaker modules 4 and the ears of the user are 5 mm to 80 mm, the audio listening experience is the best, and the problem of discomfort such as stuffiness and sweating because the ears of a headphone user are enclosed is also solved. Meanwhile, this product has the direction identification function of the human auricles, thereby making a sound direction more accurate.

Referring to FIG. 3, the plurality of speaker units in each near-ear speaker module 4 include five full-range speaker units and one bass speaker unit that are arranged in three layers. A middle layer includes three of the full-range speaker units, and the other two full-range speaker units and a sound outlet end of the bass speaker unit are respectively arranged above and below the full-range speaker units of the middle layer.

Based on a correspondence relationship between the near-ear speaker modules 4 and the left and right ears, a front-rear layout relationship of the plurality of speaker units in each near-ear speaker module 4 is as follows:

One of the full-range speaker units in an upper layer is configured to receive an upper front surround channel signal, and the other full-range speaker unit in the upper layer is configured to receive an upper rear surround channel signal.

Among the full-range speaker units in the middle layer, a rear full-range speaker unit is configured to receive a rear surround channel signal. As for the other two full-range speaker units, when a middle full-range speaker unit is configured to receive a front surround channel signal, a front full-range speaker unit is configured to receive a center channel signal and the left and right channel signals, or when the middle full-range speaker unit is configured to receive a center channel signal and the left and right channel signals, the front full-range speaker unit is configured to receive the front surround channel signal.

The bass speaker unit is configured to receive a bass channel signal.

### Embodiment 10

This embodiment is specifically as follows: The left half side of the headphone is used as an example. In the left near-ear speaker module 4, among the full-range speaker units in the upper layer, a front full-range speaker unit is an upper-front transducer 410 for receiving a left front upper surround channel signal, and a rear full-range speaker unit is an upper-rear transducer 420 for receiving a left rear upper surround channel signal. Two transducers, which are symmetrical with the upper-front transducer 410 and the upper-rear transducer 420 on the left half side of the headphone, on the right half side of the headphone respectively receive a right front upper surround channel signal and a right rear upper surround channel signal.

The left half side of the headphone is used as an example. When a user uses the system to watch a movie, a movie mode may be adopted, and a surround system of a corresponding home theater is required. In the left near-ear speaker module 4, among the full-range speaker units in the middle layer, a middle full-range speaker unit is a middle-middle transducer 430 for receiving a left front surround channel signal, a front full-range speaker unit is a middle-front transducer 440 for receiving a center channel signal and left channel signal, and a rear full-range speaker unit is a middle-rear transducer 450 for receiving a left rear surround channel signal. Three horns, which are symmetrical with the middle-middle transducer 430, the middle-front transducer 440, and the middle-rear transducer 450 on the left half side of the headphone, on the right half side of the headphone respectively receive a right front surround channel signal, a center channel signal and right channel signal, and a right rear surround channel signal.

The left half side of the headphone is used as an example. When a user uses the system to play a game, an actual orientation mode needs to be referred to, and a game mode may be adopted. In the left near-ear speaker module 4, among the full-range speaker units in the middle layer, a middle full-range speaker unit is a middle-middle transducer 430 for receiving a center channel signal and left channel signal, a front full-range speaker unit is a middle-front transducer 440 for receiving a left front surround channel signal, and a rear full-range speaker unit is a middle-rear transducer 450 for receiving a left rear surround channel signal. Three horns, which are symmetrical with the middle-middle transducer 430, the middle-front horn 440, and the middle-rear transducer 450 on the left half side of the headphone, on the right half side of the headphone respectively receive a center channel signal and right channel signal, a right front surround channel signal, and a right rear surround channel signal.

The left half side of the headphone is used as an example. In the left near-ear speaker module 4, the bass speaker unit arranged below the full-range speaker units in the middle layer is a lower transducer 460 for receiving a bass channel signal. A transducer, which is symmetrical with the lower transducer 460, on the right half side of the headphone also receives a bass channel signal.

In some embodiments, the lower transducer 460 is not limited to using the bass speaker unit, and can also use a full-range speaker unit.

In some embodiments, the bass speaker unit, namely the lower transducer 460, is arranged at a position below the full-range speaker units in the middle layer.

In some embodiments, a sound outlet hole corresponding to the sound outlet end of the bass speaker unit is formed in a housing of the near-ear speaker module. The bass speaker unit, namely the lower transducer 460, is not arranged below the full-range speaker units in the middle layer. Instead, the sound outlet hole of the lower transducer 460 is provided below the full-range speaker units in the middle layer. When the lower transducer 460 has a relatively large volume, the lower horn is arranged behind the full-range speaker units in the middle layer, and outputs a sound through the sound outlet tunnel. This proper layout optimizes the space volume occupancy of the near-ear speaker module 4.

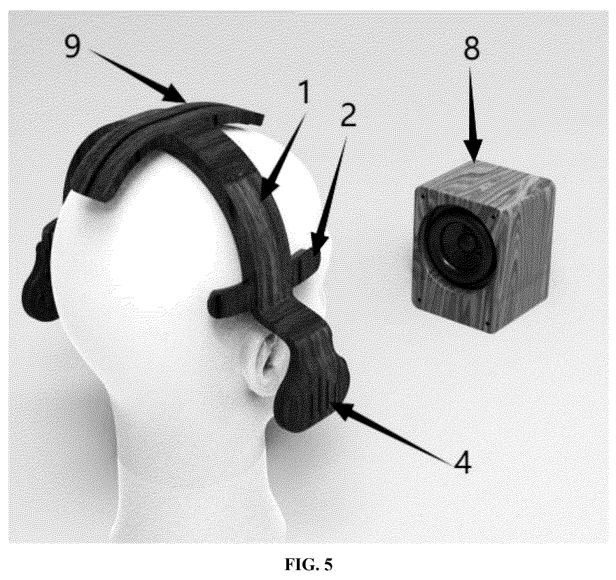

Referring to FIG. 3 and FIG. 5, the near-field surround sound system includes an external speaker 8. The plurality of speaker units in each near-ear speaker module 4 include five full-range speaker units that are arranged in an upper layer and a lower layer. The lower layer includes three full-range speaker units and the upper layer includes two full-range speaker units.

Based on a correspondence relationship between the near-ear speaker modules 4 and the left and right ears, a front-rear layout relationship of the plurality of speaker units in each near-ear speaker module 4 is as follows:

A front full-range speaker unit in the upper layer is configured to receive an upper front surround channel signal, and a rear full-range speaker unit in the upper layer is configured to receive an upper rear surround channel signal.

Among the full-range speaker units in the lower layer, a rear full-range speaker unit is configured to receive a rear surround channel signal. As for the other two full-range speaker units, when a middle full-range speaker unit is configured to receive a front surround channel signal, a front full-range speaker unit is configured to receive center channel signal and left and right channel signals, or when the middle full-range speaker unit is configured to receive the center channel signal and left and right channel signals, the front full-range speaker unit is configured to receive the front surround channel signal.

The external speaker 8 is configured to receive a bass channel signal.

### Embodiment 11

Compared with Embodiment 10, Embodiment 11 cancels the lower transducer 460 in the left and right near-ear speaker modules 4. Instead, the external speaker 8 disposed outside and the left and right near-ear speaker modules 4 form a far-field and near-field combined surround sound system. The external speaker 8 can be moved conveniently because it is just a speaker. Therefore, compared with a fixed professional near-field surround sound system and a home theater sound system, in which, a plurality of sound systems are placed at locations in a room based on a predetermined rule; and if a user walks or moves away from an optimal listening area, the listening effect will decrease. The near-field surround sound system in this embodiment and the foregoing embodiments is an open system, so that sounds from a far-field bass speaker can be transmitted to the ears of the user without obstruction, thereby achieving combined far-field and near-field sound replay for mutual complementation. Furthermore, the near-field speaker system can be worn on the head of the user all the time and move with the user. The speaker units are kept a distance from the ears of the user, and the distance remains stable, without significant variation. The external speaker 8 can be moved by the user conveniently, so that the listening effect can be continuously ensured. The activity of the user is not affected, and the experience is better.

When the external speaker 8 may be a speaker with a built-in storage battery, the external speaker 8 can be connected, through a wireless module, e.g. a Bluetooth module, to the speaker units connected to or indirectly connected to the headband main body 1 to form a system. By allocation of corresponding software and modules, sounds with corresponding frequencies in audios are played back.

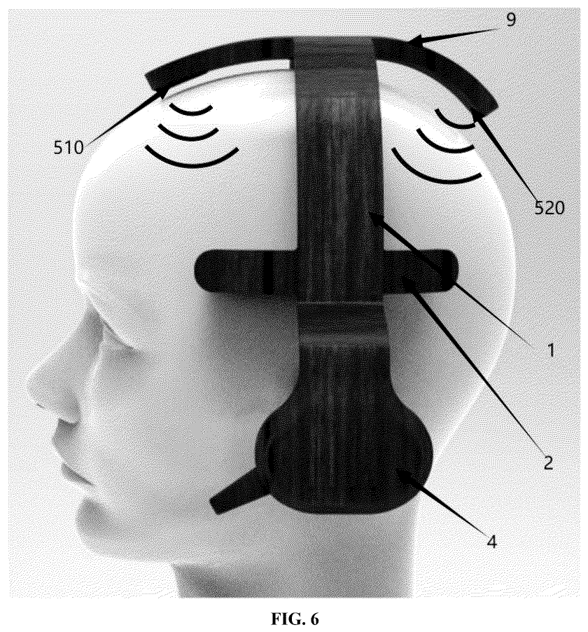

Referring to FIG. 2 and FIG. 6, the top speaker module 5 is arranged on a front side of the headband main body 1. The top speaker module 5 is a bass speaker unit or a full-range speaker unit and is configured to receive a bass channel signal.

### Embodiment 12

The top speaker module 5 arranged on the front side of the headband main body 1 is a front-top transducer 510 for receiving the bass channel signal, to form a near-field surround sound system together with the plurality of speaker units in the near-ear speaker modules 4, thus providing a better listening experience.

Referring to FIG. 2 and FIG. 6, at least one top speaker module 5 is provided, which is arranged on the front side and/or a rear side of the headband main body 1 and is configured to receive a surround channel signal.

### Embodiment 13

Referring to FIG. 2 and FIG. 6, one top speaker module 5 is provided, which is arranged on a front side of the headband main body 1. The top speaker module 5 is a front-top transducer 510 for receiving an upper surround channel signal.

### Embodiment 14

Referring to FIG. 6, one top speaker module 5 is provided, which is arranged on a rear side of the headband main body 1. The top speaker module 5 is a rear-top transducer 520 for receiving an upper surround channel signal.

### Embodiment 15

Referring to FIG. 6, one top speaker module 5 is provided, which is arranged on a rear side of the headband main body 1. The top speaker module 5 is a rear-top transducer 520 for receiving a rear upper surround channel signal.

### Embodiment 16

Referring to FIG. 6, two top speaker modules 5 are provided. One top speaker module 5 is arranged on a front side of the headband main body 1 and is a front-top transducer 510. The other top speaker module 5 is arranged on a rear side of the headband main body 1 and is a rear-top transducer 520. Both the top speaker modules are configured to revive an upper surround channel signal.

### Embodiment 17

Referring to FIG. 6, two top speaker modules 5 are provided. One top speaker module 5 is arranged on a front side of the headband main body 1 and is a front-top transducer 510 for receiving a front surround channel signal. The other top speaker module 5 is arranged on a rear side of the headband main body 1 and is a rear-top transducer 520 for receiving a rear upper surround channel signal.

The top speaker modules 5 include two speaker units respectively arranged on the front side of the headband main body 1 and on a lower end surface of a top end of the headband main body 1 or at a position, close to the lower end surface of the top end of the headband main body 1, on the front side of the headband main body 1. The speaker unit arranged on the front side of the headband main body 1 is configured to receive a center channel signal. The speaker unit arranged on the lower end surface of the top end of the headband main body 1 or at the position, close to the lower end surface of the top end of the headband main body 1, on the front side of the headband main body 1 is configured to receive an upper surround channel signal.

### Embodiment 18

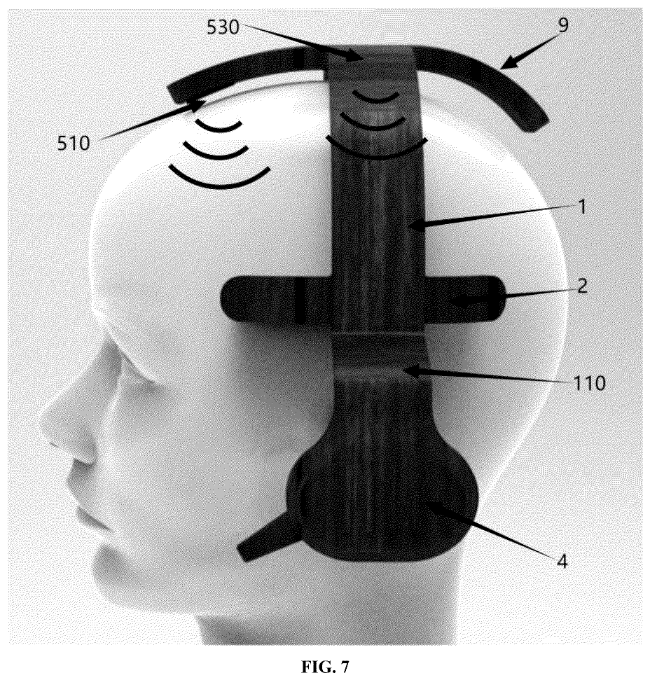

Referring to FIG. 7, a top speaker module 5 arranged on a front side of the headband main body 1 is a front-top transducer 510 for receiving a center channel signal. A top speaker module 5 arranged on a lower end surface of a top end of the headband main body 1 is a middle-top transducer 530 for receiving an upper surround channel signal.

### Embodiment 19

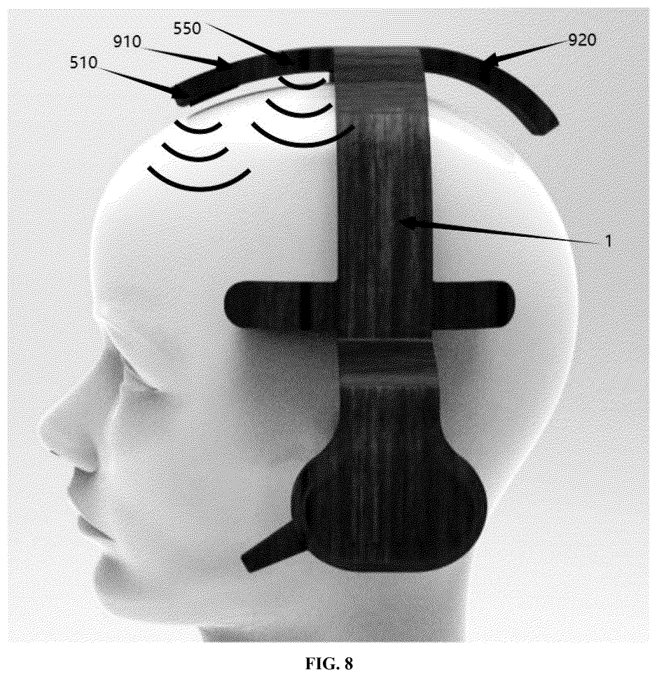

Referring to FIG. 8, a top speaker module 5 arranged on a front side of the headband main body 1 is a front-top transducer 510 for receiving a center channel signal. A top speaker module 5 arranged at a position, close to a lower end surface of a top end of the headband main body 1, on the front side of the headband main body 1 is a top-front transducer 550 for receiving an upper surround channel signal.

### Embodiment 20

Referring to FIG. 2, a top speaker module 5 arranged on a front side of the headband main body 1 is a front-top horn 510 for receiving a center channel signal. A top speaker module 5 arranged at a position, close to a lower end surface of a top end of the headband main body 1, on a rear side of the headband main body 1 is a top-rear horn (not shown) for receiving an upper surround channel signal.

### Embodiment 21

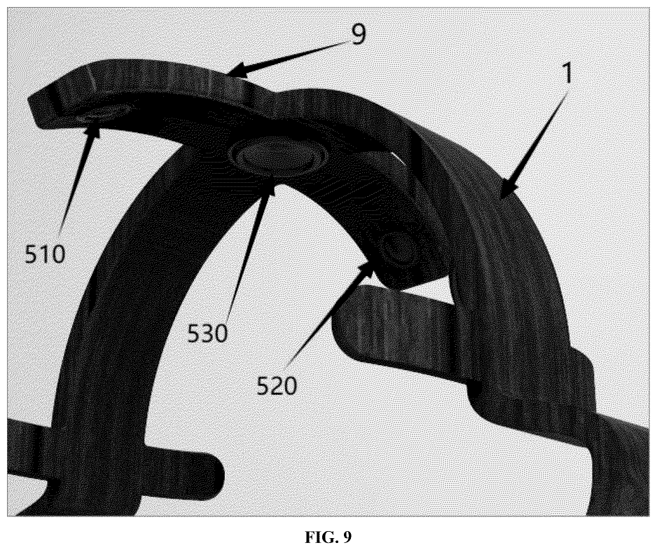

Referring to FIG. 9, the top speaker module 5 includes three speaker units respectively arranged on a front side and a rear side of the headband main body 1 to receive an upper surround channel signal and on a lower end surface of a top end of the headband main body 1 to receive a bass channel signal.

Referring to FIG. 8 and FIG. 9, the near-field surround sound system includes a supporting plate 9. The supporting plate 9 is at least connected to a front side of a top end of the headband main body 1, and a curvature of the supporting plate 9 conforms to a crown curvature of the head. The top speaker module 5 is connected to the headband main body 1 through the supporting plate 9.

The curvature of the supporting plate 9 conforms to the crown curvature of the head, which can make the supporting plate 9 better abut against the head of a user, and the connection is more stable.

The supporting plate 9 is disposed based on an arrangement position and the quantity of the top speaker module 5. A plate structure of the supporting plate 9 that is connected to the front side of the top end of the headband main body 1 is a front supporting plate 910, and a plate structure of the supporting plate 9 that is connected to the rear side of the top end of the headband main body 1 is a rear supporting plate 920. The front supporting plate 910 and the rear supporting plate 920 may be structures integrated with the headband main body 1 and may be frames or plates.

The front supporting plate 910 extends from a connection position with the front side of the top end of the headband main body 1 toward the forehead of the head. The rear supporting plate 920 extends from a connection position with the rear side of the top end of the headband main body 1 toward the back side of the head.

When the supporting plate 9 adopts the structure including both the front supporting plate 910 and the rear supporting plate 920, the supporting plate 9 cooperates with the auxiliary clamping frames 2, thus further enhancing the stability of wearing of a user. Preferably, flexible pads arranged on end surfaces of the supporting plate 9 and the auxiliary clamping frames 2 that abut against the head of a user to enhance the comfort level.

Sounds of audio files are mainly replayed through a speaker, a headphone, and the like. A home theater sound system can replay multi-channel audio content, bringing an immersive experience. However, most multi-channel home theater sound systems have the following problems: indoor wiring affects indoor aesthetics, speakers occupy an indoor space, later mounting affects the existing interior decoration, playing back sounds affects people around, and the like. Therefore, the near-field surround sound system provides the following specific solutions to address these pain points in the prior art.

### Embodiment 22

Referring to FIG. 10, the near-field surround sound system includes a front-top transducer 540 arranged on a front side of a top of the headband main body 1 and configured to receive a center channel signal; a flexibly supplementary speaker unit 10 configured to receive a flexibly supplementary channel signal; and at least one middle speaker module 6 which is arranged at any one of the following positions: in the auxiliary clamping frames 2, adjacent to the auxiliary clamping frames 2, and in the connecting portions 110, and is configured to receive a flexibly supplementary channel signal. The plurality of speaker units in each near-ear speaker module 4 include five full-range speaker units and one bass speaker unit that are disposed in three layers. A middle layer includes three full-range speaker units, and the other two full-range speaker units and the bass speaker unit are respectively disposed above and below the middle layer.

Based on a correspondence relationship between the near-ear speaker modules 4 and the left and right ears, a front-rear layout relationship of the plurality of speaker units in each near-ear speaker module 4 is as follows:

One of the full-range speaker units in an upper layer is configured to receive an upper front surround channel signal, and the other full-range speaker unit in the upper layer is configured to receive an upper rear surround channel signal.

Among the full-range speaker units in the middle layer, a rear full-range speaker unit is configured to receive a rear surround channel signal. As for the other two full-range speaker units, when a middle full-range speaker unit is configured to receive a front surround channel signal, a front full-range speaker unit is configured to receive a center channel signal and left and right channel signals, or when the middle full-range speaker unit is configured to receive a center channel signal and the left and right channel signals, the front full-range speaker unit is configured to receive the front surround channel signal.

The bass speaker unit is configured to receive a bass channel signal.

This embodiment is specifically as follows: The left half side of the system is used as an example. In the left near-ear speaker module 4, among the full-range speaker units in the upper layer, a front full-range speaker unit is an upper-front transducer 410 for receiving left front upper surround channel signals, and a rear full-range speaker unit is an upper-rear transducer 420 for receiving left rear upper surround channel signal. Two transducers, which are symmetrical with the upper-front transducer 410 and the upper-rear transducer 420 on the left half side of the headphone, on the right half side of the system respectively receive a right front upper surround channel signal and a right rear upper surround channel signal.

The left half side of the headphone is used as an example. When a user uses the system to watch a movie, a movie mode may be adopted, and a surround system of a corresponding home theater is required. In the left near-ear speaker module 4, among the full-range speaker units in the middle layer, a middle full-range speaker unit is a middle-middle transducer 430 for receiving a left front surround channel signal, a front full-range speaker unit is a middle-front transducer 440 for receiving a center channel signal and left channel signal, and a rear full-range speaker unit is a middle-rear transducer 450 for receiving a left rear surround channel signal. Three transducers, which are symmetrical with the middle-middle transducer 430, the middle-front transducer 440, and the middle-rear transducer 450 on the left half side of the headphone, on the right half side of the headphone respectively receive a right front surround channel signal, a center channel signal and right channel signal, and a right rear surround channel signal.

The left half side of the headphone is used as an example. When a user uses the system to play a game, an actual orientation mode needs to be referred to, and a game mode may be adopted. In the left near-ear speaker module 4, among the full-range speaker units in the middle layer, a middle full-range speaker unit is a middle-middle transducer 430 for receiving a center channel signal and left channel signal, a front full-range speaker unit is a middle-front transducer 440 for receiving a left front surround channel signal, and a rear full-range speaker unit is a middle-rear transducer 450 for receiving a left rear surround channel signal. Three transducers, which are symmetrical with the middle-middle transducer 430, the middle-front transducer 440, and the middle-rear transducer 450 on the left half side of the headphone, on the right half side of the headphone respectively receive a center channel signal and right channel signal, a right front surround channel signal, and a right rear surround channel signal.

The left half side of the headphone is used as an example. In the left near-ear speaker module 4, the bass speaker unit arranged below the full-range speaker units in the middle layer is a lower transducer 460 for receiving a bass channel signal. A transducer, which is symmetrical with the lower transducer 460, on the right half side of the headphone also receives a bass channel signal.

The flexibly supplementary speaker unit 10 and the middle speaker module 6 can serve as flexible supplements for the sound effect of the system.

In some embodiments, the lower transducer 460 is not limited to using the bass speaker unit, and can also use a full-range speaker unit.

In some embodiments, the bass speaker unit, namely the lower transducer 460, is not arranged below the full-range speaker units in the middle layer. Instead, a sound outlet hole of the lower transducer 460 is provided below the full-range speaker units in the middle layer. When the lower transducer 460 has a relatively large volume, the lower transducer is arranged behind the full-range speaker units in the middle layer, or the lower transducer is arranged behind the full-range speaker units in the upper layer and the full-range speaker units in the middle layer. The lower transducer 460 outputs a sound through the sound output hole provided in a housing of the near-ear speaker module 4.

This system with speaker unit structure arrangement and channel signal allocation enables the system to correspondingly implement 7.2.4 surround sound speaker system, thus achieving the sound effect of the system.

To achieve a balance in the left and right near-ear speaker modules 4, both the left and right near-ear speaker modules 4 are provided with bass speaker units. If only one of the left and right near-ear speaker modules 4 is provided with a bass speaker unit, the headphone corresponds to a 7.1.4 surround sound speaker system. Alternatively, neither of the left and right near-ear speaker modules 4 is provided with a base speaker unit, and an external speaker 8 that receives a bass channel signal is used in conjunction with the headphone to correspondingly implement a 7.1.4 surround sound speaker system.

### Embodiment 23

When neither of the left and right near-ear speaker modules 4 in Embodiment 22 is provided with full-range speaker units in an upper layer, or is provided with the full-range speaker units in the upper layer, but does not transmit an upper surround sound channel signal to the full-range speaker units in the upper layer, so that the headphone corresponds to a 7.2 surround sound speaker system, thus achieving the sound effect of the system.

To achieve a balance in the left and right near-ear speaker modules 4, both the left and right near-ear speaker modules 4 are provided with bass speaker units. If only one of the left and right near-ear speaker modules 4 is provided with a bass speaker unit, the headphone corresponds to a 7.1 surround sound speaker system. Alternatively, neither of the left and right near-ear speaker modules 4 is provided with a base speaker unit, and an external speaker 8 that receives a bass channel signal is used in conjunction with the headphone to correspondingly implement a 7.1 surround sound speaker system.

Through the layout of Embodiment 22 or Embodiment 23, the system is improved into a miniaturized surround sound or panoramic sound system. After a user starts to play back audios, an audio file signal is transmitted to a decoder on a main control board, and the decoder allocates channel signals. After adjusting different combinations of signal values such as EQ settings, Gain increase and decrease, dynamic range control (DRC), phase, and delay of channels such as left and right surround channels, front and rear surround channels, a center channel, and a top surround channel, a digital signal processor (DSP) transmits the combinations to a power amplifier. The power amplifier transmits amplified signals to the channels. After the signals of the channels are received by the corresponding speaker units, the signals are played back, thus presenting a perfect surround sound field or panoramic sound field to the user. The main control board is connected, in a wired manner through a headphone cable or a wireless module, to a device for playing back audios. For example, the main control board is connected, via Bluetooth, to the device for pushing and playing back audios.

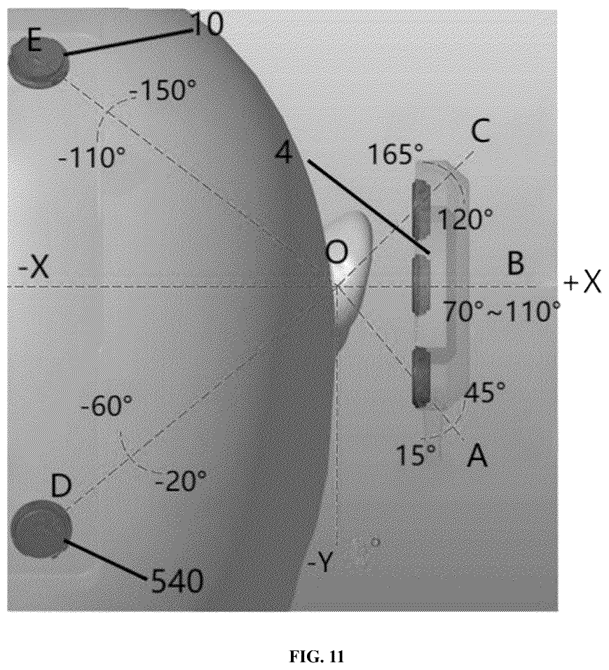

Referring to FIG. 11 to FIG. 13, by using an entrance of the left ear canal as a central origin O, introducing a planar rectangular coordinate system with an X axis and a Y axis, and using a negative axial line of the Y axis as a starting line −YO, when the near-field surround sound system is worn in a top-view projection, a layout of the speaker units on the top and the left side of the near-field surround sound system is as follows:
an angle formed by a connecting line from a position point of the front full-range speaker unit, namely the middle-front transducer 440, in the middle layer to the central origin and the starting line is 15° to 45°;
an angle formed by a connecting line from a position point of the middle full-range speaker unit, namely the middle-middle transducer 430, in the middle layer to the central origin and the starting line is 70° to 110°;
an angle formed by a connecting line from a position point of the rear full-range speaker unit, namely the middle-rear transducer 450, in the middle layer to the central origin and the starting line is 120° to 165°;
an angle formed by a connecting line GO from a position point G of the full-range speaker unit for receiving the upper front surround channel signal in the upper layer to the central origin O and the starting line −YO is 65° to 80°;
an angle formed by a connecting line HO from a position point H of the full-range speaker unit for receiving the upper rear surround channel signal in the upper layer to the central origin O and the starting line −YO is 110° to 125°;
an angle formed by a connecting line DO from a position point D of the top-front speaker unit 540 to the central origin O and the starting line −YO is −20° to −60°; and
an angle formed by a connecting line EO from a position point E of the flexibly supplementary speaker unit 10 to the central origin O and the starting line −YO is −110° to −150°.

By using the entrance of the left ear canal as the central origin O, introducing a space rectangular coordinate system with an X axis, a Y axis, and a Z axis, and using a positive axial line of the X axis as a starting line XO, when the near-field surround sound system is worn in a right-view projection, an angle formed by a connecting line FO from a position point F of the full-range speaker unit in the upper layer on a left side of the near-field surround sound system to the central origin O and the starting line XO is 30° to 70°.

The inventor repeatedly tunes the layout through research and development, and arranges the speaker units in the system of Embodiment 22 or Embodiment 23 based on the foregoing directional ranges, thus ultimately causing the headphone to achieve a playback sound effect that is the same as the sound effect of a professional home theater sound system, and greatly enhancing the user experience.

Therefore, a corresponding relationship of placement with the speaker of the surround sound system is as follows: the middle-front transducer 440 on the left side of the system and the middle-front transducer on the right side respectively correspond to a left channel speaker and a right channel speaker in the surround sound system, and the top-front speaker unit 540 corresponds to a center speaker in the surround sound system.

The middle-front transducer 440 and the middle-front transducer on the right side of the headphone can be responsible for managing scene sounds of most pictures in a movie and reducing a corresponding large-scale sound effect, including background music in the movie. Especially when magnificent scenes are paired with large-scale music, they are inspiring. With a deep bass effect, the overall experience is extremely impressive.

A main function of the top-front speaker unit 540 is to replay human voice dialogues and mid-to high-frequency ranges in the movie. It concentrates the human voice dialogues in the middle of a sound field of an entire screen and plays a crucial role in reflecting the effect and smoothness of human voices.

The middle-middle transducers 430 on the left and right half sides correspond to surround speakers respectively arranged on the left and right sides of the home theater system, while the middle-rear transducers 450 on the left and right sides correspond to two back surround speakers on a back wall portion of a video room. By combining the top-front speaker unit 540 and the middle-front transducer 440, the seven speaker units can accurately locate sounds in pictures in the sound system. The positions in which the sounds appear are sound parts that need to be reduced and amplified by the corresponding surround speakers, which can play a role in connecting the preceding and the following. It provides a good link with a sound field in front and also allows a user to hear an environmental sound effect in the back, thus allowing the user to be surrounded by the sound field and creating create a sense of liveness and atmosphere. Meanwhile, it can also render a shocking, surround-sound immersive spatial experience, enhance the texture of movie audio, and achieve natural transitioning and smoothing during sound image movement.

The bass speaker unit, also known as the lower transducer 460 or the external speaker 8, corresponds to a subwoofer in the home theater surround sound system. The lower transducer 460 or the external speaker 8 is the soul of this near-field surround sound system. All magnificent and spectacular scene sounds in the movie are enhanced by the lower transducer 460 or the external speaker 8. In a movie soundtrack, the super bass performance is mainly concentrated around 60 Hz, and is as low as 40 Hz in most movies. An on-site sound pressure level can reach more than 100 dB, making explosion sounds and earth-shaking sounds in the movies more realistic and shocking.

The four speaker units such as the left upper-front transducer 410, the left upper-rear transducer 420, the right upper-front transducer, and the right upper-rear transducer correspond to four sky channel speakers on the roof of the video room with a panoramic sound system, thus achieving the audio effect of a Dolby Atmos home theater system. A user can use this system to listen to audios and feel that the headphones reproduce any sound in the sky, such as airplane hovering, thunder, and rain, as if the user was there.

Through the foregoing solution, the speakers of the home theater sound system can be brought closer to the head of a user. A sound pressure level is in inverse proportion to a square of a distance. The near-field speakers in the system do not require a high sound pressure output, thus reducing the volume of the speaker. The volume of the near-field speaker module 4 is controlled, and a replay effect of the existing home theater system is achieved by customizing and tuning the near-field speakers. Compared with a headphone, the near-field speaker system fully utilizes the ability of the ear auricles for recognizing a sound direction by reserving a distance between the system and the human ears, so that the surround sound system is closer to a real natural listening state, thereby enhancing the sense of presence of the surround sound system.

Therefore, the system can essentially achieve a high-quality sound effect equivalent to that of the surround sound or panoramic sound system.

In summary, according to the near-field surround sound system, through tuning and verification, the headband of the conventional headphone is improved, and the problem of discomfort such as stuffiness and sweating because the headphone encloses and covers the ears of a user is solved. The auxiliary clamping frames 2 are used to clamp the two sides of the head of the user, namely to clamp areas close to the ear bases of the two ears, so that the problem in stability of connection between the headband main body 1 after improvement the headphone and the head of the user is solved. By the arrangement of the plurality of speaker units in the near-ear speaker modules 4, as well as supplementing specific speaker units or speaker unit groups in a top region of the headband main body 1 and regions of the auxiliary clamping frames 2, the speaker units receive specific channel signals, so that the headphone becomes a near-field surround sound system or a panoramic sound effect is achieved. This greatly enhances the user experience and matches a standard professional home theater sound system. Moreover, compared with a home theater sound system, the near-field surround sound system is easy to carry, saves a space, and is convenient to use. Sound interference to a surrounding environment, such as a neighbors' living environment, during the operation of the home theater sound system is avoided. Meanwhile, this product has the direction identification function of the human auricles, thereby making a sound direction more accurate.

### Embodiment 24

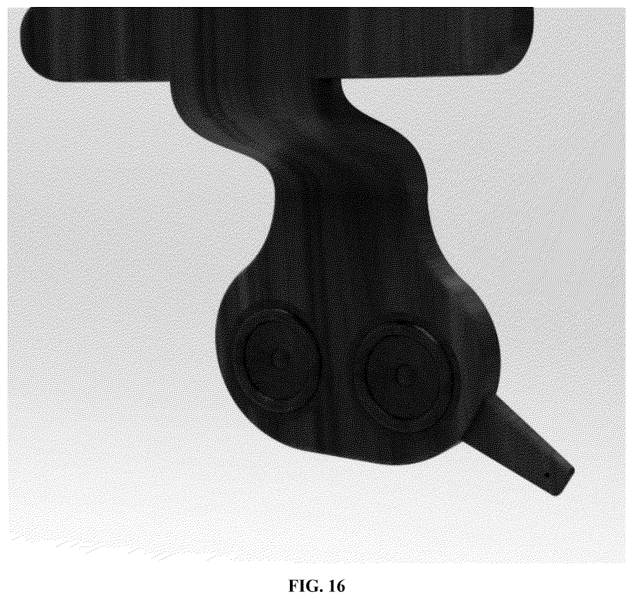

Referring to FIG. 16, the plurality of speaker units in each near-ear speaker module include two full-range speaker units. Based on a correspondence relationship between the near-ear speaker modules and the left and right ears, the two full-range speaker units in each near-ear speaker module are disposed front and rear. The front full-range speaker unit is configured to receive a center channel signal and receive left and right channel signals. The rear full-range speaker unit is configured to receive rear left and right surround channel signals.

### Embodiment 25

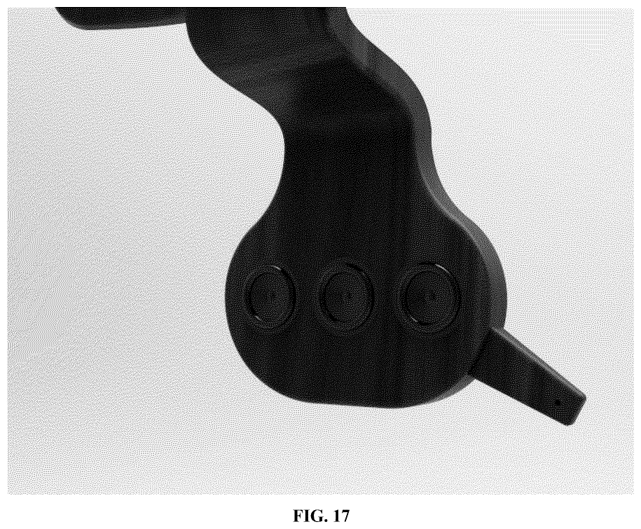

Referring to FIG. 17, the plurality of speaker units in each near-ear speaker module 4 include three full-range speaker units. Based on a correspondence relationship between the near-ear speaker modules 4 and the left and right ears, the three full-range speaker units in each near-ear speaker module 4 are disposed front, middle, and rear.

The front full-range speaker unit is configured to receive any one of a center channel signal and left and right channel signals, or left and right front surround channel signals.

The middle full-range speaker unit is configured to receive any one of left and right front surround channel signals or a center channel signal and left and right channel signals.
the rear full-range speaker unit is configured to receive rear left and right rear surround channel signals.

### Embodiment 26

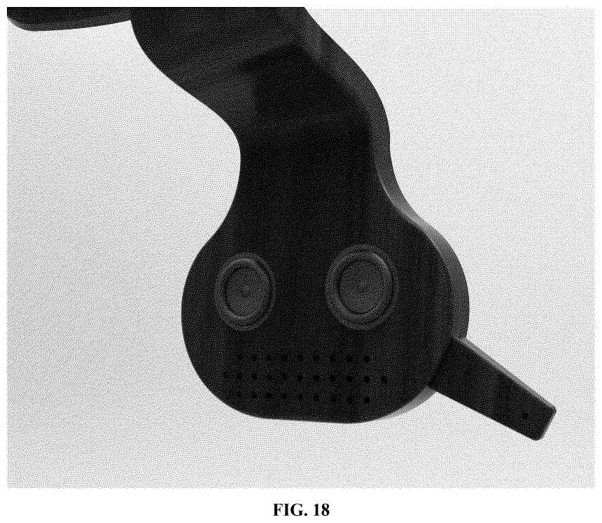

Referring to FIG. 18, the plurality of speaker units in each near-ear speaker module 4 include three speaker units. Based on a correspondence relationship between the near-ear speaker modules 4 and the left and right ears, the three speaker units in each near-ear speaker module 4 are disposed in two layers, and an upper layer includes two speaker units that are disposed front and rear.

The front speaker unit in the upper layer is configured to receive a center channel signal and left and right channel signals, or left and right front surround channel signals.

The rear speaker unit in the upper layer is configured to receive left and right rear surround channel signals.

The speaker unit in the lower layer is configured to receive bass channel signals.

In this embodiment, the speaker unit in the lower layer may be a full-range speaker unit or a low-range speaker unit, and other speaker units are preferably full-range speaker unit.

### Embodiment 27

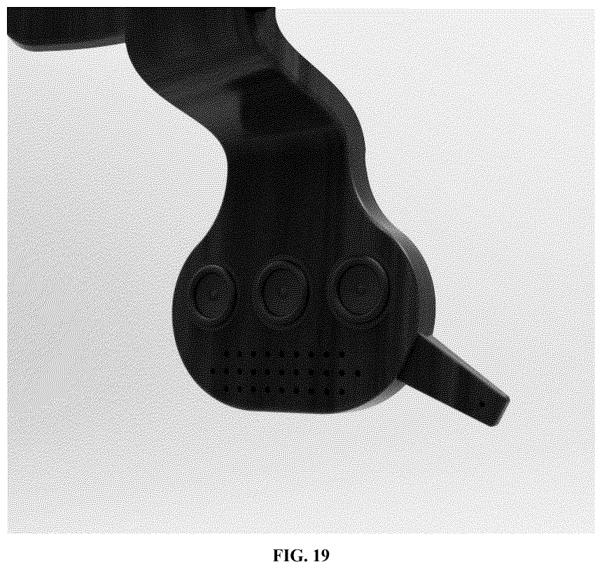

Referring to FIG. 19, the plurality of speaker units in each near-ear speaker module 4 include four speaker units. Based on a correspondence relationship between the near-ear speaker modules 4 and the left and right ears, the four speaker units in each near-ear speaker module 4 are disposed in two layers, and an upper layer includes three speaker units that are disposed front, middle, and rear.

The front speaker unit in the upper layer is configured to receive a center channel signal and left and right channel signals, or left and right front surround channel signals.

The middle speaker unit in the upper layer is configured to receive a center channel signal and left and right channel signals, or left and right front surround channel signals.

The rear speaker unit in the upper layer is configured to receive left and right rear surround channel signals.

The speaker unit in the lower layer is configured to receive bass channel signals.

In this embodiment, the speaker unit in the lower layer may be a full-range speaker unit or a low-range speaker unit, and other speaker units are preferably full-range speaker unit.

### Embodiment 28

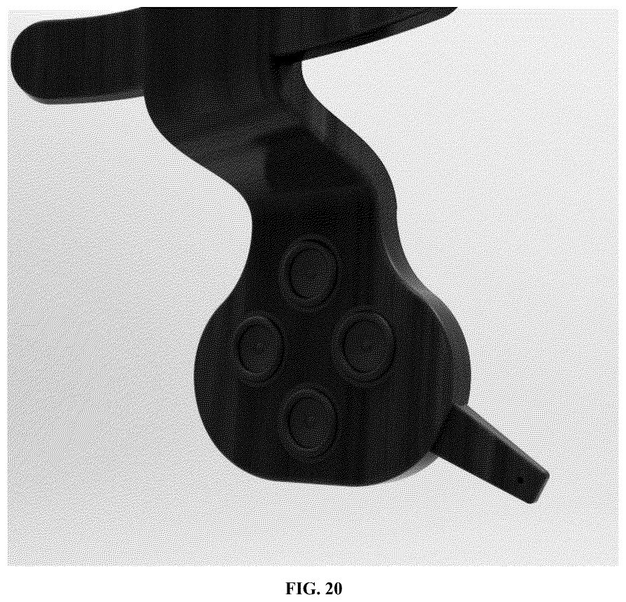

Referring to FIG. 20, the plurality of speaker units in each near-ear speaker module 4 include four full-range speaker units. Based on a correspondence relationship between the near-ear speaker modules and the left and right ears, the four full-range speaker units in each near-ear speaker module are disposed in three layers, and a middle layer includes two full-range speaker units that are disposed front and rear.

The full-range speaker unit in the upper layer is configured to receive left and right upper surround channel signals.

The front full-range speaker unit in the middle layer is configured to receive a center channel signal and left and right channel signals, or left and right front surround channel signals.

The rear full-range speaker unit in the middle layer is configured to receive left and right surround channel signals.

The full-range speaker unit in the lower layer is configured to receive a center channel signal and left and right channel signals, or left and right front surround channel signals.

### Embodiment 29

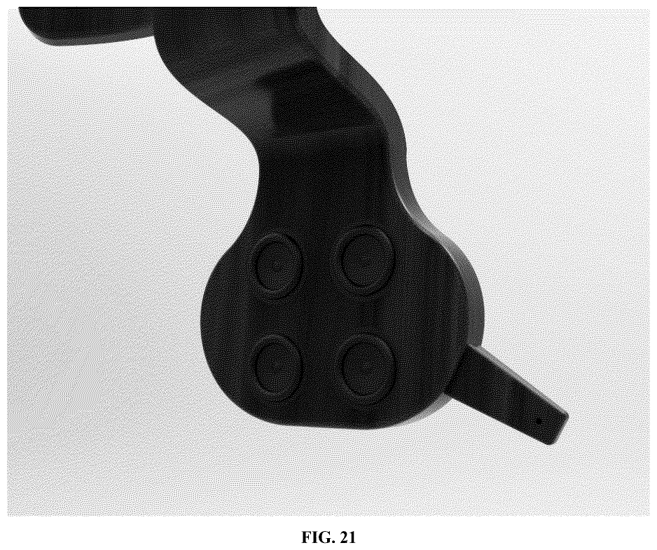

Referring to FIG. 21, the plurality of speaker units in each near-ear speaker module 4 include four full-range speaker units. Based on a correspondence relationship between the near-ear speaker modules 4 and the left and right ears, the four full-range speaker units in each near-ear speaker module 4 are disposed in two layers, and each of an upper layer and a lower layer includes two full-range speaker units that are disposed front and rear.

The front full-range speaker unit in the upper layer is configured to receive left and right upper front surround channel signals.

The rear full-range speaker unit in the upper layer is configured to receive left and right upper rear surround channel signals.

The front full-range speaker unit in the lower layer is configured to receive a center channel signal and left and right channel signals.

The rear full-range speaker unit in the lower layer is configured to receive left and right surround channel signals.

### Embodiment 30

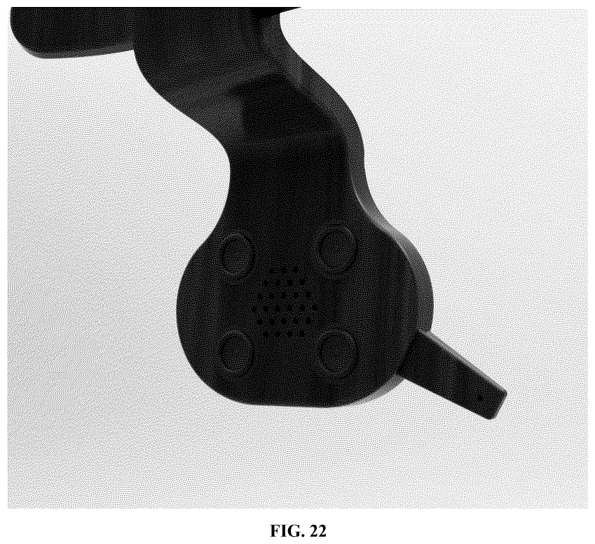

Referring to FIG. 22, the plurality of speaker units in each near-ear speaker module 4 include five speaker units. Based on a correspondence relationship between the near-ear speaker modules 4 and the left and right ears, four of the speaker units in each near-ear speaker module 4 are disposed in two layers. Each of an upper layer and a lower layer includes two speaker units that are disposed front and rear. The fifth speaker unit is disposed between the four speaker units.

The front speaker unit in the upper layer is configured to receive left and right upper front surround channel signals.

The rear speaker unit in the upper layer is configured to receive left and right upper rear surround channel signals.

The front speaker unit in the lower layer is configured to receive a center channel signal and left and right channel signals.

The rear speaker unit in the lower layer is configured to receive left and right surround channel signals.

The fifth speaker unit is configured to receive bass channel signals.

In this embodiment, the fifth speaker unit may be a full-range speaker unit or a low-range speaker unit, and other speaker units are preferably full-range speaker unit.

### Embodiment 31

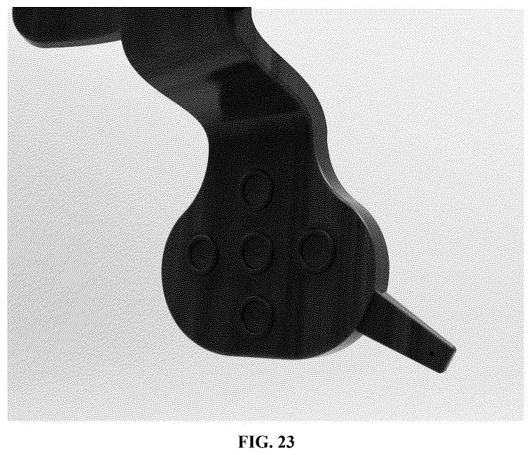

Referring to FIG. 23, the plurality of speaker units in each near-ear speaker module 4 include five speaker units. Based on a correspondence relationship between the near-ear speaker modules 4 and the left and right ears, the five speaker units in each near-ear speaker module 4 are disposed in three layers. A middle layer includes three speaker units that are disposed front, middle, and rear.

The speaker unit in the upper layer is configured to receive left and right upper surround channel signals.

The front speaker unit in the middle layer is configured to receive a center channel signal and left and right channel signals, or left and right front surround channel signals.

The middle speaker unit in the middle layer is configured to receive a center channel signal and left and right channel signals, or left and right front surround channel signals.

The rear speaker unit in the middle layer is configured to receive left and right rear surround channel signals.

The speaker unit in the lower layer is configured to receive bass channel signals.

In this embodiment, the speaker unit in the lower layer may be a full-range speaker unit or a low-range speaker unit, and other speaker units are preferably full-range speaker unit.

In some embodiments, the near-ear speaker modules 4 are connected to the headband main body 1 through the connecting portions 110 in an adjustable manner. When a user wears the headband main body 1, the near-ear speaker modules 4 can adjust distances from the auricles of the ears of the user by 5 mm to 80 mm through the connecting portions 110.

The connecting portions 110 may be metal gooseneck structures and may be moved by a user to desired positions and then automatically shaped. Alternatively, the connecting portions 110 are rotatably connected to the headband main body 1. Rotatable connection positions have frictional damping. After an external force disappears, the connecting positions are kept in adjusted positions. Thus, the near-ear speaker modules 4 can adjust the distances from the auricles of the ears of the user by 5 mm to 80 mm, to meet user needs.

### Embodiment 32

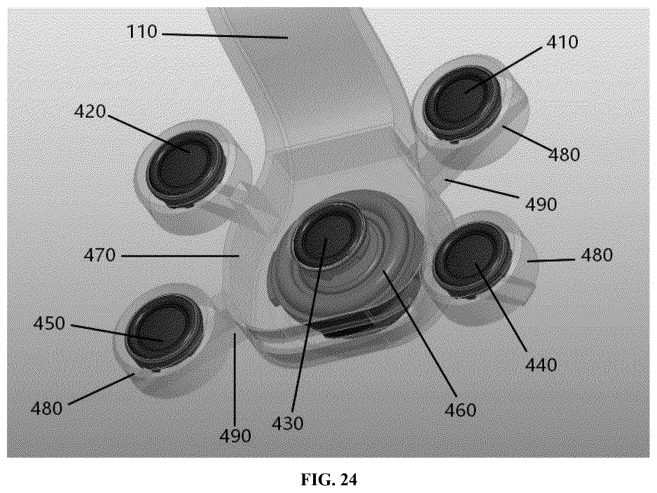

Referring to FIG. 24, the near-ear speaker module 4 includes a main supporting housing 470, a plurality of auxiliary supporting housings 480, and connecting arms 490. At least one speaker unit is mounted on the main supporting housing 470 and the auxiliary supporting housings 480. The auxiliary supporting housings 480 are connected to the main supporting housing 470 through the connecting arms 490 and are arranged at peripheral edges of the main supporting housing 470. The main supporting housing 470 is connected to the connecting portions 110.

Referring to FIG. 1 to FIG. 8, FIG. 10, and FIG. 14 to FIG. 23, in the foregoing embodiments, the single near-ear speaker module 4 employs an entire integrated box-shaped housing for mounting a plurality of speaker units. The box-shaped housing occupies a relatively large area. The plurality of speaker units share an inner cavity of the box-shaped housing as a back cavity and affect each other.

In this embodiment, by the arrangement of the main supporting housing 470 and the auxiliary supporting housings 480, the plurality of speaker units are isolated. An independent cavity design can optimize and enhance the working sound quality of the speaker units at corresponding positions. Further, mounting housings are arranged at layout positions of the speaker units, thereby avoiding the richness of the overall box-shaped housing, eliminating part of redundant housing structures, and enhancing the appearance effect with enhanced technological sense and aesthetic appeal.

The layout of the main supporting housing 470, the auxiliary supporting housings 480, and the plurality of speaker units can be implemented by using the foregoing position layout solution and a channel signal input type.

The connecting arms 490 are plastically deformable shaped tube bodies. The auxiliary supporting housings 480 have adjustable positions relative to the main supporting housing 470 through the connecting arms 490.

In some embodiments, the plastically deformable shaped tube bodies are of metal shaped hose structures. The positions of the auxiliary supporting housings 480 can be manually directly adjusted relative to the main supporting housing 470, so as to adjust the positions of the speaker units on the auxiliary supporting housings 480 and meet a requirement for a listening experience of a user. The positions are self-adapted according to different face shapes of different users, to enhance the user experience. Inner holes of metal shaped hoses can be used for allowing electric wires connected to the speaker units to pass through.

### Embodiment 33

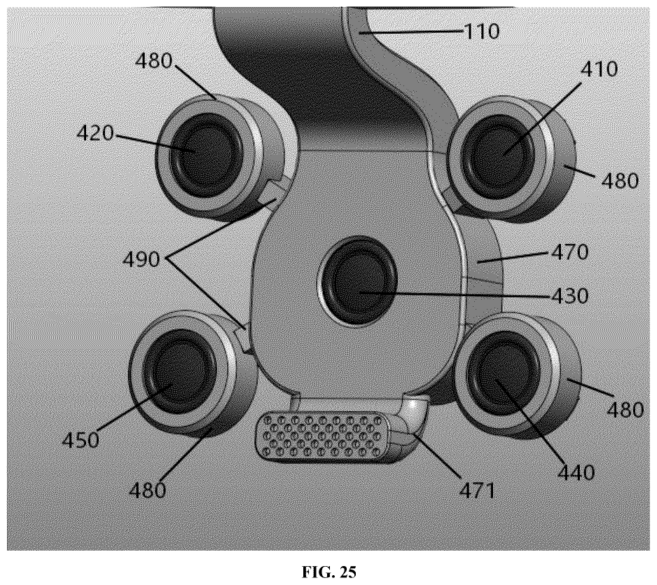

Referring to FIG. 25, the main supporting housing 470 is provided with a base speaker unit for receiving a bass channel signal. A sound outlet hole which corresponds to the bass speaker unit and has a sound outlet surface facing the head of the user is formed in a side surface of the main supporting housing 470. Alternatively, an acoustic cavity channel 471 with a bent structure is arranged at a lower end of the main supporting housing 470. A sound outlet of the acoustic cavity channel 471 faces the head of the user.

The bass speaker unit, namely the lower transducer 460, is arranged on the main supporting housing 470. As described in the foregoing embodiment, the middle-middle transducer 430 is arranged adjacent to the lower transducer 460. The middle-middle transducer 430 and the main supporting housing 470 are together mounted on the main supporting housing 470. By specifically designing the corresponding sound outlet hole or acoustic cavity channel 471 for the lower transducer 460, the sound output effect of the bass speaker unit can be ensured to be fully exerted.

The upper-front transducer 410, the upper-rear transducer 420, the middle-front transducer 440, and the middle-rear transducer 450 are respectively mounted on different auxiliary supporting housings 480 and are distributed around the main supporting housing 470 according to corresponding orientations.

What is claimed is:

1. A near-field surround sound system, comprising:
a headband main body provided with connecting portions at two ends;
auxiliary clamping frames arranged adjacent to upper ends of the connecting portions, wherein the auxiliary clamping frames are connected to two side surfaces of the headband main body, and curvatures of the auxiliary clamping frames are configured to correspond to curvatures of two sides of the head;
flexible pads arranged on end surfaces of the headband main body and the auxiliary clamping frames that abut against the head; and
two near-ear speaker modules respectively connected to the two connecting portions, wherein each near-ear speaker module comprises a plurality of speaker units; and when a user wears the headband main body, the connecting portions are configured to cause the near-ear speaker modules to be not in contact with the ears of the user.

2. The near-field surround sound system according to claim 1, comprising a top speaker module, wherein the top speaker module is connected to the headband main body and is approximately arranged at a top end of the headband main body, with a sound outlet surface facing the head.

3. The near-field surround sound system according to claim 1, comprising at least one middle speaker module arranged at any one of the following positions: in the auxiliary clamping frames, adjacent to the auxiliary clamping frames, and in the connecting portions; and the middle speaker module is configured to receive any one of left and right surround channel signals, left upper and right upper surround channel signals, a bass channel signal, a center channel signal, and a combination of one or more of the foregoing signals.

4. The near-field surround sound system according to claim 1, wherein when the user wears the headband main body, distances between the near-ear speaker modules and the auricles of the ears of the user are 5 mm to 80 mm through the connecting portions.

5. The near-field surround sound system according to claim 1, wherein the plurality of speaker units in each near-ear speaker module comprise five full-range speaker units and one bass speaker unit that are arranged in three layers; a middle layer comprises three of the full-range speaker units, and the other two full-range speaker units and a sound outlet end of the bass speaker unit are respectively arranged above and below the full-range speaker units of the middle layer;
based on a correspondence relationship between the near-ear speaker modules and the left and right ears, a front-rear layout relationship of the plurality of speaker units in each near-ear speaker module is as follows:
one of the full-range speaker units in an upper layer is configured to receive an upper front surround channel signal, and the other full-range speaker unit in the upper layer is configured to receive an upper rear surround channel signal;
among the full-range speaker units in the middle layer, a rear full-range speaker unit is configured to receive a rear surround channel signal; as for the other two full-range speaker units, when a middle full-range speaker unit is configured to receive a front surround channel signal, a front full-range speaker unit is configured to receive a center channel signal and left and right channel signals, or when the middle full-range speaker unit is configured to receive a center channel signal and the left and right channel signals, the front full-range speaker unit is configured to receive the front surround channel signal; and
the bass speaker unit is configured to receive a bass channel signal.

6. The near-field surround sound system according to claim 1, comprising an external speaker, wherein the plurality of speaker units in each near-ear speaker module comprise five full-range speaker units that are arranged in an upper layer and a lower layer; the lower layer comprises three full-range speaker units and the upper layer comprises two full-range speaker units;
based on a correspondence relationship between the near-ear speaker modules and the left and right ears, a front-rear layout relationship of the plurality of speaker units in each near-ear speaker module is as follows:
a front full-range speaker unit in the upper layer is configured to receive an upper front surround channel signal, and a rear full-range speaker unit in the upper layer is configured to receive an upper rear surround channel signal;
among the full-range speaker units in the lower layer, a rear full-range speaker unit is configured to receive a rear surround channel signal; as for the other two full-range speaker units, when a middle full-range speaker unit is configured to receive a front surround channel signal, a front full-range speaker unit is configured to receive a center channel signal and left and right channel signals, or when the middle full-range speaker unit is configured to receive a center channel signal and the left and right channel signals, the front full-range speaker unit is configured to receive the front surround channel signal; and
the external speaker is configured to receive a bass channel signal.

7. The near-field surround sound system according to claim 2, wherein the top speaker module is arranged on a front side of the headband main body; the top speaker module is a bass speaker unit or a full-range speaker unit and is configured to receive a bass channel signal.

8. The near-field surround sound system according to claim 2, wherein at least one top speaker module is provided, which is arranged on a front side and/or a rear side of the headband main body and is configured to receive an upper surround channel signal.

9. The near-field surround sound system according to claim 2, wherein the top speaker module comprises two speaker units respectively arranged on a front side of the headband main body and on a lower end surface of a top end of the headband main body or at a position, close to the lower end surface of the top end of the headband main body, on the front side of the headband main body; the speaker unit arranged on the front side of the headband main body is configured to receive a center channel signal; and the speaker unit arranged on the lower end surface of the top end of the headband main body or at the position, close to the lower end surface of the top end of the headband main body, on the front side of the headband main body is configured to receive an upper surround channel signal.

10. The near-field surround sound system according to claim 2, wherein the top speaker module comprises three speaker units respectively arranged on a front side and a rear side of the headband main body to receive front and rear upper surround channel signals and on a lower end surface of a top end of the headband main body to receive a bass channel signal.

11. The near-field surround sound system according to claim 2, comprising a supporting plate, wherein the supporting plate is at least connected to a front side of a top end of the headband main body, and a curvature of the supporting plate conforms to a crown curvature of the head; and the top speaker module is connected to the headband main body through the supporting plate.

12. The near-field surround sound system according to claim 5, comprising a top-front speaker unit arranged on a front side of a top of the headband main body and configured to receive a center channel signal; a flexibly supplementary speaker unit configured to receive a flexibly supplementary channel signal; and at least one middle speaker module which is arranged at any one of the following positions: in the auxiliary clamping frames, adjacent to the auxiliary clamping frames, and in the connecting portions, and is configured to receive a flexibly supplementary channel signal; the plurality of speaker units in each near-ear speaker module comprise five full-range speaker units and one bass speaker unit that are disposed in three layers; a middle layer comprises three full-range speaker units, and the other two full-range speaker units and the bass speaker unit are respectively disposed above and below the middle layer;
based on a correspondence relationship between the near-ear speaker modules and the left and right ears, a front-rear layout relationship of the plurality of speaker units in each near-ear speaker module is as follows:
one of the full-range speaker units in an upper layer is configured to receive an upper front surround channel signal, and the other full-range speaker unit in the upper layer is configured to receive an upper rear surround channel signal;
among the full-range speaker units in the middle layer, a rear full-range speaker unit is configured to receive a rear surround channel signal; as for the other two full-range speaker units, when a middle full-range speaker unit is configured to receive a front surround channel signal, a front full-range speaker unit is configured to receive a center channel signal and left and right channel signals, or when the middle full-range speaker unit is configured to receive a center channel signal and the left and right channel signals, the front full-range speaker unit is configured to receive the front surround channel signal; and
the bass speaker unit is configured to receive a bass channel signal.

13. The near-field surround sound system according to claim 12, wherein by using an entrance of the left ear canal as a central origin, introducing a planar rectangular coordinate system with an X axis and a Y axis, and using a negative axial line of the Y axis as a starting line, from a top view, when the near-field surround sound system is worn, a layout of the speaker units on the top and the left side of the near-field surround sound system is as follows:
an angle formed by a connecting line from a position point of the front full-range speaker unit in the middle layer to the central origin and the starting line is 15° to 45°;
an angle formed by a connecting line from a position point of the middle full-range speaker unit in the middle layer to the central origin and the starting line is 70° to 110°;
an angle formed by a connecting line from a position point of the rear full-range speaker unit in the middle layer to the central origin and the starting line is 120° to 165°;
an angle formed by a connecting line from a position point of the full-range speaker unit for receiving the upper front surround channel signal in the upper layer to the central origin and the starting line is 65° to 80°;
an angle formed by a connecting line from a position point of the full-range speaker unit for receiving the upper rear surround channel signal in the upper layer to the central origin and the starting line is 110° to 125°;
an angle formed by a connecting line from a position point of the top-front speaker unit to the central origin and the starting line is −20° to −60°;
an angle formed by a connecting line from a position point of the flexibly supplementary speaker unit to the central origin and the starting line is −110° to −150°; and
by using the entrance of the left ear canal as the central origin, introducing a space rectangular coordinate system with an X axis, a Y axis, and a Z axis, and using a positive axial line of the X axis as a starting line, when the near-field surround sound system is worn in a right-view projection, an angle formed by a connecting line from a position point of the full-range speaker unit in the upper layer on a left side of the near-field surround sound system to the central origin and the starting line is 30° to 70°.

14. The near-field surround sound system according to claim 1, wherein the plurality of speaker units in each near-ear speaker module comprise two full-range speaker units; based on a correspondence relationship between the near-ear speaker modules and the left and right ears, the two full-range speaker units in each near-ear speaker module are disposed front and rear; the front full-range speaker unit is configured to receive a center channel signal and receive left and right channel signals; and the rear full-range speaker unit is configured to receive left and right surround channel signals.

15. The near-field surround sound system according to claim 1, wherein the plurality of speaker units in each near-ear speaker module comprise three full-range speaker units; based on a correspondence relationship between the near-ear speaker modules and the left and right ears, the three full-range speaker units in each near-ear speaker module are disposed front, middle, and rear;
the front full-range speaker unit is configured to receive a center channel signal and left and right channel signals, or left and right front surround channel signals;
the middle full-range speaker unit is configured to receive left and right front surround channel signals, or a center channel signal and left and right channel signals; and
the rear full-range speaker unit is configured to receive rear left and right rear surround channel signals.

16. The near-field surround sound system according to claim 1, wherein the plurality of speaker units in each near-ear speaker module comprise three speaker units; based on a correspondence relationship between the near-ear speaker modules and the left and right ears, the three speaker units in each near-ear speaker module are disposed in two layers, and an upper layer comprises two speaker units that are disposed front and rear;
the front speaker unit in the upper layer is configured to receive any one of a center channel signal and left and right channel signals;
the rear speaker unit in the upper layer is configured to receive left and right surround channel signals; and
the speaker unit in the lower layer is configured to receive bass channel signals.

17. The near-field surround sound system according to claim 1, wherein the plurality of speaker units in each near-ear speaker module comprise four speaker units; based on a correspondence relationship between the near-ear speaker modules and the left and right ears, the four speaker units in each near-ear speaker module are disposed in two layers, and an upper layer comprises three speaker units that are disposed front, middle, and rear;
the front speaker unit in the upper layer is configured to receive a center channel signal and left and right channel signals, or left and right front surround channel signals;
the middle speaker unit in the upper layer is configured to receive a center channel signal and left and right channel signals, or left and right front surround channel signals;
the rear speaker unit in the upper layer is configured to receive left and right rear surround channel signals; and
the speaker unit in the lower layer is configured to receive rear bass channel signals.

18. The near-field surround sound system according to claim 1, wherein the plurality of speaker units in each near-ear speaker module comprise four full-range speaker units; based on a correspondence relationship between the near-ear speaker modules and the left and right ears, the four full-range speaker units in each near-ear speaker module are disposed in three layers, and a middle layer comprises two full-range speaker units that are disposed front and rear;
the full-range speaker unit in the upper layer is configured to receive left and right upper surround channel signals;
the front full-range speaker unit in the middle layer is configured to receive a center channel signal and left and right channel signals, or left and right front surround channel signals;
the rear full-range speaker unit in the middle layer is configured to receive left and right surround channel signals; and
the full-range speaker unit in the lower layer is configured to receive a center channel signal and left and right channel signals, or left and right front surround channel signals.

19. The near-field surround sound system according to claim 1, wherein the plurality of speaker units in each near-ear speaker module comprise four full-range speaker units; based on a correspondence relationship between the near-ear speaker modules and the left and right ears, the four full-range speaker units in each near-ear speaker module are disposed in two layers, and each of an upper layer and a lower layer comprises two full-range speaker units that are disposed front and rear;
the front full-range speaker unit in the upper layer is configured to receive left and right upper front surround channel signals;
the rear full-range speaker unit in the upper layer is configured to receive left and right upper rear surround channel signals;
the front full-range speaker unit in the lower layer is configured to receive a center channel signal and left and right channel signals; and
the rear full-range speaker unit in the lower layer is configured to receive left and right surround channel signals.

20. The near-field surround sound system according to claim 1, wherein the plurality of speaker units in each near-ear speaker module comprise five speaker units; based on a correspondence relationship between the near-ear speaker modules and the left and right ears, four of the speaker units in each near-ear speaker module are disposed in two layers; each of an upper layer and a lower layer comprises two speaker units that are disposed front and rear; the fifth speaker unit is disposed between the four speaker units;
the front speaker unit in the upper layer is configured to receive left and right upper front surround channel signals;
the rear speaker unit in the upper layer is configured to receive left and right upper rear surround channel signals;
the front speaker unit in the lower layer is configured to receive a center channel signal and left and right channel signals;
the rear speaker unit in the lower layer is configured to receive left and right surround channel signals; and
the fifth speaker unit is configured to receive bass channel signals.

21. The near-field surround sound system according to claim 1, wherein the plurality of speaker units in each near-ear speaker module comprise five speaker units; based on a correspondence relationship between the near-ear speaker modules and the left and right ears, the five speaker units in each near-ear speaker module are disposed in three layers; a middle layer comprises three speaker units that are disposed front, middle, and rear;
the speaker unit in the upper layer is configured to receive left and right upper front surround channel signals;
the front speaker unit in the middle layer is configured to receive a center channel signal and left and right channel signals, or left and right front surround channel signals;
the middle speaker unit in the middle layer is configured to receive a center channel signal and left and right channel signals, or left and right front surround channel signals;
the rear speaker unit in the middle layer is configured to receive left and right rear surround channel signals; and
the speaker unit in the lower layer is configured to receive bass channel signals.

22. The near-field surround sound system according to claim 1, wherein the near-ear speaker modules are connected to the headband main body through the connecting portions in an adjustable manner; and when the user wears the headband main body, the near-ear speaker modules adjust distances from the auricles of the ears of the user by 5 mm to 80 mm through the connecting portions.

23. The near-field surround sound system according to claim 1, wherein the near-ear speaker module comprises a main supporting housing, a plurality of auxiliary supporting housings, and connecting arms; at least one speaker unit is mounted on the main supporting housing and the auxiliary supporting housings; the auxiliary supporting housings are connected to the main supporting housing through the connecting arms and are arranged at peripheral edges of the main supporting housing; and the main supporting housing is connected to the connecting portions.

24. The near-field surround sound system according to claim 23, wherein the connecting arms are plastically deformable shaped tube bodies; and the auxiliary supporting housings have adjustable positions relative to the main supporting housing through the connecting arms,

25. The near-field surround sound system according to claim 23, wherein the main supporting housing is provided with a base speaker unit for receiving a bass channel signal; a sound outlet hole which corresponds to the bass speaker unit and has a sound outlet surface facing the head of the user is formed in a side surface of the main supporting housing; alternatively, an acoustic cavity channel with a bent structure is arranged at a lower end of the main supporting housing; and a sound outlet of the acoustic cavity channel faces the head of the user.
